(19) United States
(12) Patent Application Publication
(10) Pub. No.: US 2013/0029300 A1
(43) Pub. Date: Jan. 31, 2013

(54) Method for Competency Assessment of Healthcare Students and Practitioners

(71) Applicants: Jay Shiro Tashiro, Tucson, AZ (US); Miguel Vargas Martin, Oshawa (CA); Chak Kuen Patrick Hung, Markham (CA)

(72) Inventors: Jay Shiro Tashiro, Tucson, AZ (US); Miguel Vargas Martin, Oshawa (CA); Chak Kuen Patrick Hung, Markham (CA)

(21) Appl. No.: 13/633,053

(22) Filed: Oct. 1, 2012

Related U.S. Application Data
(63) Continuation-in-part of application No. 12/730,153, filed on Mar. 23, 2010, now abandoned.

(51) Int. Cl. G09B 19/00

(52) U.S. Cl. 434/219

(57) ABSTRACT

A method to assess the competency of a healthcare practitioner, comprising providing a learning object repository comprising a plurality of virtual objects including a plurality of virtual patients, wherein said learning object repository does not comprise a physical patient manikin; and displaying on a visual display device a virtual clinical world comprising a plurality of virtual objects retrieved from said learning object repository. The method further includes selecting by a practitioner a virtual patient from said virtual clinical world, tracking patient interactions, tracking selected patient data, and generating an AssessMap reciting an assessment grid comprising a plurality of Performance Levels in combination with a plurality of categories for each Performance Level.

### CROSS REFERENCE TO RELATED APPLICATIONS

This application is a Continuation-In-Part of U.S. Non-Provisional application having Ser. No. 12/730,153 filed on Mar. 23, 2010, which in turns claims priority from a U.S. Provisional Application having Ser. No. 61/162,597, filed on Mar. 23, 2009, and which are hereby incorporated by reference.

### FIELD OF THE INVENTION

The present invention relates generally to assessing the complex clinical competencies of healthcare students and practitioners and more particularly to assessing such competencies while also improving students' and practitioners' skills and knowledge critical to improving clinical competencies.

### BACKGROUND OF THE INVENTION

In today's healthcare systems, worldwide, there is a need for healthcare providers with high levels of clinical competencies. This is true across the spectrum of healthcare systems, including systems in the United States such as individual hospitals, clusters of hospitals under health management organizations, outpatient clinics, primary care practices, and assisted living centers, but also the healthcare planning and delivery agencies such as the Local Health Integration Networks of Ontario, Canada, as well as in other regional healthcare planning and delivery agencies in other Provinces of Canada.

Despite this clear and pressing need, there is still a lack of evidence-based frameworks for educational and training methods and materials that have a strong research base for developing such clinical competencies. The deficiencies of the prior art is a result from a plurality of factors.

A first deficiency factor arises because care of patients occurs within clinical and home settings that have environments that vary in time and space, i.e. differing temporal and spatial heterogeneity. Extreme examples of temporal and spatial heterogeneity occur within battlefields as well as in emergency trauma environments. In both clinical and home settings, the circumstances of care, the number and types of care giving personnel, and the equipment used to deliver care may vary through time (e.g., moment to moment changes in circumstances as well as availability of personnel and equipment) and space (e.g., variation across location in terms of circumstances as well as availability of personnel and equipment).

A second deficiency factor arises because an individual person with a disease or injury has physiological and psychosocial processes that also vary through time and within the space of their body. In short, there is tremendous complexity in the emergence of interactions between the temporal variability of both environment in which care is delivered and of the patient's physiological and psychosocial process. Evidence-based practice has been difficult to implement because of the multivariate nature of such emergence complexities between human physiological and psychosocial systems and the multivariate nature of healthcare interventions that must be implemented within the care giving setting for any particular disease or injury state.

Yet, for healthcare students to become healthcare practitioners, and for healthcare practitioners to become clinical experts, both students and practitioners must develop higher order thinking that can be accurately applied in a timely fashion to make clinical decisions that improve patient outcomes. Together, such decisions constitute a domain of clinical judgment capacity for any healthcare providers and students. High quality clinical judgment is crucial for improved patient outcomes along the gradient from battlefields and emergency trauma units to healthcare settings that maintain a relatively stable quality of direct patient care and for patient's in such settings that have a disease or injury condition that is not rapidly changing.

A third deficiency factor arises because the prior art does not provide solutions to the first two deficiencies in ways that allow measurement of at least two kinds of competencies, conceptual competencies and performance competencies. Here, we are using conceptual competencies as a thorough understanding of a knowledge and/or skills domain. Often conceptual competencies are further elaborated as: (1) competencies in which a person can describe how and why to use the knowledge or skill in different but appropriate contexts (generativity); and (2) competencies in which a person can describe how to use the knowledge or skill in situations that are unfamiliar (robustness). However, performance competencies are those competencies in which knowledge is acted on as an expression of a variety of behaviors and decisions or skills that are implemented in the real world or some very close simulation of the real world. In relation to the first two deficiency factors, within care delivery settings cognition will be shaped by the situated encounters in that workplace, which are dynamic and strongly influenced by social contexts as well as by a diverse array of other elements in the setting such as technology, temporal and spatial heterogeneity in the patient's condition, changing shifts of providers caring for the same patient, and ongoing coordination of many different tasks and decisions as well as health information management. Effective action requires development of pattern recognition capabilities as providers move from novice to expert. Such pattern recognition capabilities are critical to clinical judgment and decision-making during planning and implementing care. Often, the decision making unfolds in a “heuristically-guided” sequence. Yet, the prior art does not allow creation of customized environments in which healthcare students' and practitioners' conceptual and performance competencies can be measured automatically. Importantly, the prior art does not allow assessment of the completeness of pattern recognition development. In particular, prior art does not allow automated delineation of misconception development. For example, what is the probability that working in an educational environment leads student or practitioner users to tangential analyses and making decisions that are logical to the result of such analyses but that are flawed as pattern recognition or are fraught with misconceptions? Importantly, the advances in social learning environment and social networking can be integrated into learning and training environment in the following ways: (1) focusing on students; (2) personalizing learning; (3) discovering experts; (4) distributing authorship; (5) liberating knowledge; (6) roaming and learning; and (7) creating accountability. Such integration opens new opportunities for building teaching-learning-assessment environments that may enhance competency development as well as automated competency assessment with a particular focus on automated assessment for misconceptions within either conceptual or performance competency domains.

A fourth deficiency factor arises because as healthcare students and practitioners engage in educational activities or training there must be adequate sampling of what they learn, what learning they retain, and what learning they can transfer into care giving practices. Interestingly, as both the care giving environment and the patient become more temporally and spatially heterogeneous, educators realize more completely the extreme importance of assessing spatial and temporal heterogeneity of the critical educational outcome variables that are supposed to measure an individual healthcare student's or practitioner's clinical judgment. This fourth deficiency is one of the reasons that misconceptions have not been automatically delineated in learning environments, even with the use of high fidelity simulations coupled to knowledge or intelligence systems.

A fifth deficiency factor arises because of the absence of a theoretical framework that drives an interpretive framework for development of clinical judgment that would inform selection of processes for data collection and analysis of students' and practitioners' learning outcomes, stability of these outcomes, and transferability of these outcomes to clinical practice. For example, even if the third and fourth deficiency factors described above could be addressed, current intelligence systems, data mining applications, and other analytical systems have not captured the breadth and depth that temporal and spatial heterogeneity of care giving for complex patients in complex environments might have on development of clinical judgment. Some make the claim that high fidelity manikin simulations and their programmable conditional logic systems, as well as other prior art embodied by knowledge or intelligence systems, approach breadth and depth in simulated temporal-spatial heterogeneity of clinical conditions, but such systems are not coupled to automated probes of the end users interactions in ways that sufficiently delineate misconception development. Consequently, the prior art fails to provide empirically derived educational methods and materials that facilitate ongoing educational and training interventions likely to create opportunities for enhanced continuous quality improvement in clinical judgment.

A sixth deficiency factor arises because even if the prior five deficiencies could be overcome, individual faculty members and staff educators do not agree on a singular theory of cognition or a theory of behavioral change. Consequently, the prior art fails to provide educational methods and materials that have the flexibility to accommodate any theory of cognition and a theory of behavioral change because each theory or theory combination would have particular types of educational activities and learning assessments as well as particular types and arrangements of educational scaffolding to support a learner within learning environments.

Prior art educational methods and materials have tried to couple learning activities to learning outcomes assessments using conditional logic systems that respond to end users' choices, and couple these to knowledge-based systems, data mining applications, and other analytical systems to measure what has been learned. Yet, such prior art has failed to adequately assess, the stability of the learning, and students' and practitioners' abilities to transfer the learning to practice activities, and the misconceptions developed during learning or during the situated experience of applying what they have learned. In brief, these prior art methods fail to adequately sample at any one time, let alone along the time series in order to provide sufficient information to portray the likely impacts of educational methods and materials on the development of, the stability of, and the application of clinical judgment by healthcare students and practitioners (as measured by either conceptual or performance competencies). Furthermore, prior art methods do not allow the automated measurement of misconception development by healthcare students or practitioners during and after an educational intervention. Finally, prior art provides little flexibility to customize teaching-learning-assessment environments in ways that would neither allow selection and integrate of different theories of cognition into instructional design nor allow selection and integration of measures of behavioral change resulting from an educational interventions.

The six prior art deficiency factors in combination are fundamental parts of the problem and contribute to a general failure to collect sufficient and high quality data on educational methods and materials, wherein the interpretation of such data can enhance the management of educational and training interventions and allow moving sensibly towards educational methods and materials empirically founded on evidence-based learning. Thus using prior art methods, it is not possible to analyze the trajectories of critical variables that shape the clinical judgment of and in particular the development of misconceptions by healthcare students and practitioners, the stability of such judgment with possible misconceptions embedded, the transferability of such judgment and acting on misconceptions and the subsequent impact of clinical judgment and misconceptions on the theory and praxis of healthcare planning and delivery.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram of the Applicants' method showing the modules comprising Applicants' COMPASS—Competency Assessment System;

FIG. 2 illustrates the basis of using the Learning Object Repository to build a Virtual Clinical World for assessing competencies within computer-based simulations of clinical scenarios;

FIG. 3 is a flow chart summarizing the steps of the MOLT, MALT, Pathfinder, and DATUM modules of one embodiment of Applicants' method;

FIG. 4 illustrates Applicants' FAST Subsystem modular capacities for creating different Virtual Clinical Worlds;

FIG. 5 provides details of the COMPASS MALT—Multiattribute Assessment in Latent-class module;

FIG. 6 shows the COMPASS Pathfinder and DATUM modules for one embodiment of the invention;

FIG. 7 depicts using the COMPASS Virtual Clinical World module within the Applicants' COMPASS Gateway subsystem within one embodiment of the Applicants' method;

FIG. 8 graphically illustrates the framework of the Pathfinder module;

FIG. 9 graphically illustrates Applicants' DATUM module and feedback through the Preceptor Report Dashboard within Applicants' COMPASS Gateway subsystem;

FIG. 10 shows two sample screenshots of integration of learning experiences with social networking environment online (i.e., Facebook.com and Renren.com);

FIG. 11 illustrates a diagrammatical model for mapping conceptual competencies;

FIG. 12 recites Applicant's AssessMap for the model of FIG. 11; and

FIG. 13 recites a table showing a quantum of time, and a quantification of conceptual competencies measured by both knowledge and transfer for the model of FIG. 11.

### DETAILED DESCRIPTION OF PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Many of the functional units described in this specification have been labeled as subsystems or as modules in order to more particularly emphasize their implementation independence. In one embodiment of the method, COMPASS has two subsystems, the COMPASS Architect and the COMPASS Gateway. In such an embodiment, for example, a module of a subsystem may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Subsystems or modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically collocated, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The schematic flow charts included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method.

Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Recognizing that inadequacies of the prior art contribute to a general failure to collect sufficient and high quality data on educational methods and materials, the Applicants' invention provides a computer-implemented method that: (1) in one embodiment allows a healthcare educator or trainer to select the parameters of a computer-based or Web-delivered clinical simulation in which students or practitioners can work; (2) express this type of embodiment of such a simulation as suites of learning activities, learning assessments, and educational scaffolding that can be mapped from any of several dominant theories of cognition and behavioral change; (3) allows end users to engage in the simulation while monitoring each student's or practitioner's every action and respective decisions within a simulation, collecting and parsing monitoring data from each individual as places within the simulation (e.g., Web page, simulative learning object, animation), time spent within each place, and sequelae of places visited; (4) introduces assessments of competencies, both conceptual and performance, as well as introduces measures of behavioral intention in decision-making and action taken; colleting and parsing these assessment data for each individual with mapping linkages to each place-time node in the respective individual's sequelae of places visited; (5) analyzes the monitoring data of place-time sequelae as well as the respective place-time assessment of competencies data and provides as output a set of linked data arrays; (6) provides analytical functions for examining competency assessment measures within the contexts of place-time sequelae and decisions, actions, knowledge transfer, and behavioral intentions expressed during the respective sequelae or some subset of a sequelae found during the students' or practitioners' work within the clinical simulations and, in some embodiments, while working within a social learning environment; (7 provides a knowledge system that can collate such analytical examination of competency assessment measures in various place-time contexts, and draw from repositories of recommendations based on the analysis of an individual' data from an excursion within the learning environment in ways that delineate misconception development and provide recommendations for remediating misconceptions; (8) provide both learner and trainer dashboards that enhance the management of educational and training interventions and allow moving sensibly towards educational methods and materials empirically founded on evidence-based learning; and (9) makes it possible to analyze the trajectories of the critical variables that shape the clinical judgment of healthcare students and practitioners, the stability of such judgment, the transferability of such judgment, the potential for misconceptions being developed related to such judgment, the remediation of misconceptions, and the subsequent enhancement of clinical judgment as the theory and praxis of healthcare planning and delivery is advanced.

The Applicants' invention is a system COMPASS—Competency Assessment System, comprised of two subsystems, the COMPASS Architect and the COMPASS Gateway. The COMPASS Architect subsystem 200 comprises a plurality of modules. More particularly, embodiments of Applicants' COMPASS Architect subsystem 200 provide computer-implemented environments that effectively couple teaching, learning, and learning assessment opportunities with a research engine that allows rigorous development of evidence-based learning frameworks for education. Applicants' method has been specifically designed for the education of healthcare students and practitioners. Applicants' COMPASS Architect subsystem 200 will meet the need for:

1. Customization of learning environments to reflect educators′ and trainers″ preferences for certain theories of cognition or theories of behavioral change.

2. Learning environments that help healthcare students and practitioners develop broadly based clinical competencies in physiological and psychosocial domains (both conceptual and performance) within a framework of interprofessional collaborative patient-centered care, and along the gradient from relatively simple care to care delivered in situations of complex temporal and spatial heterogeneity in patient condition and in care planning and delivery.

3. Learning environments that use adaptive strategies to probe healthcare students' and practitioners' preferences to create customized learning solutions, but that also provide diagnostic feedback for improving learning, especially when particular preferences are maladaptive for learning.

4. Learning environments with automated software that monitors an individual's activity within the learning environments, collecting data on places in the environment visited and time spent in each place as well as assessment data on what was learned in each place, the transferability of knowledge learned, the stability of knowledge gained, and the misconceptions still fond after a learning episode.

5. Learning environments that have knowledge systems providing detailed feedback to individual learners as well as summary information and statistics to an instructor for each individual learner as well as for a class of learners, with such knowledge systems creating teaching-learning environments that do not increase workloads for faculty members or staff trainers, but instead allow instructors to refocus their attention and time on strategies that improve learning outcomes and retention and professional development of students and practitioners.

6. Learning environments providing authentic assessments of complex clinical complexities that have construct validity and provide complementary training opportunities to current educational environments yet have very different functionalities and outputs than are found within extant health related teaching-training systems such as manikin simulators and standard patient scenarios while at the same time.

7. Evidence-based development of learning management system environments that meet rigorous standards for teaching, leaning, and assessment, such as those delineated by the Interprofessional Care Project of HealthForce Ontario as well as the US National Research Council, the Federation of American Scientists, and the US Institute of Medicine.

8. Coupled teaching-learning-assessment environments that automatically provide a research platform useful for developing and evaluating instructional methods and materials within a framework for evidence-based learning, as well as being applicable or cross-theory comparisons of cognitive and behavioral choice theories.

The method of the invention combines teaching, learning, learning assessment, misconception delineation, and research components that are integrated into a computer-implemented educational system that in some embodiments may be nested within social networking environments. Prior art systems utilize high fidelity manikin simulations and their programmable conditional logic systems, as well as other prior art embodied by knowledge or intelligence systems. Such prior art methods and devices are not coupled to automated probes of the end users interactions in ways that sufficiently delineate misconception development.

In certain embodiments, Applicants' apparatus does not comprise a physical simulation device comprising an artificial patient. In certain embodiments, Applicants' method does not assess manipulative skills such as and without limitation physical placement of intravenous lines, use of an endotracheal tube, use of a defibrillator, and the like. In certain embodiments, Applicants' apparatus and method do not include nor use electromechanical devices, hydraulic devices, electro-hydraulic devices, magnetic devices, pneumatic devices, variable density simulation devices, etc. In certain embodiments, Applicants' apparatus does not include an artificial patient having a simulation device built and comprising sensors that detect the placement of defibrillation paddles on the artificial patient's chest.

Applicants' apparatus and method define and utilize a virtual clinical environment. In certain embodiments, Applicants' apparatus and method assess a medical student or practitioner's evaluative and patient assessment skills.

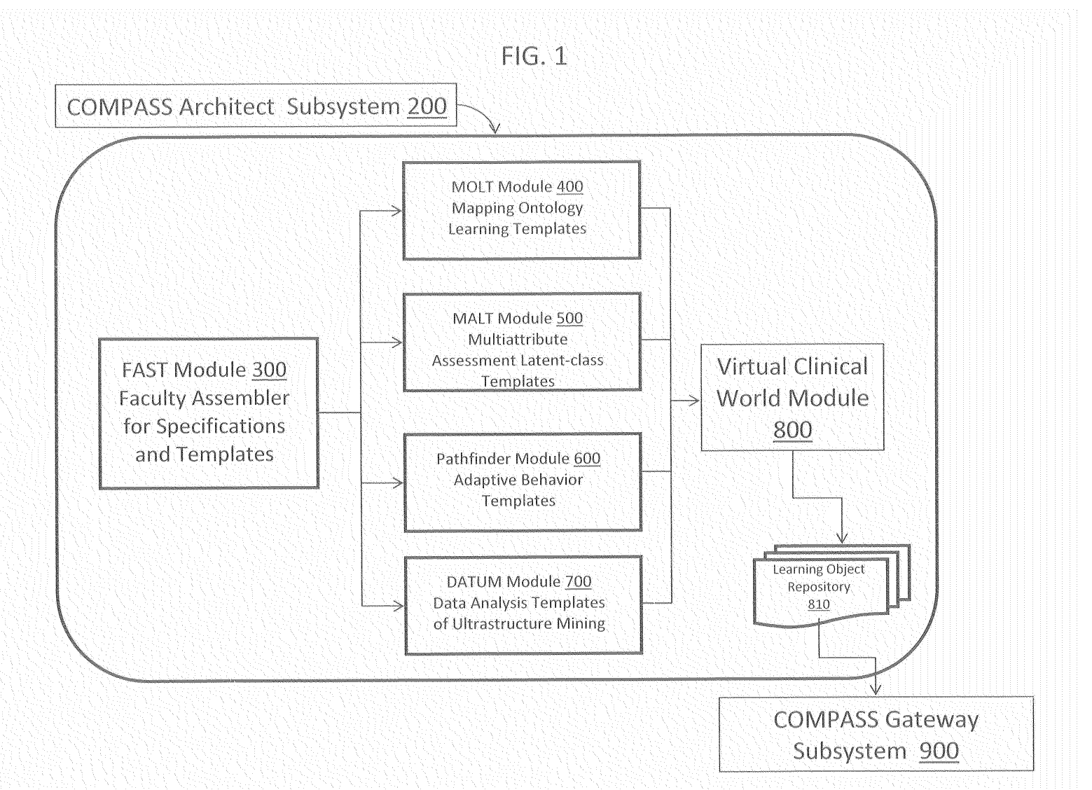

In FIG. 1, we show one preferred embodiment of Applicants' method in which the method of the invention is established within a Web-based environment that may be coupled to or nested within a social networking environment. Applicants' method utilizes the COMPASS Architect subsystem 200 that allows an instructor to create templates for clinical simulations within a Virtual Clinical World module 800. A unique feature of this embodiment is its capacity for allowing an instructor to create customized clinical simulations for any group of end users, such as healthcare students and practitioners at different states of prior skills development or knowledge. Furthermore, a second unique feature is that the instructor can choose a particular theory of cognition and a particular theory of behavior change, these choices driving creation of an instructional template based on a single theory or combination of theories of cognition and behavior. These simulations are populated by learning objects from a Learning Object Repository 810, with learning objects mapping into the customized templates that were created by choices of theories of cognition and behavior. The Virtual Clinical World is then deployed through the Applicants' method COMPASS Gateway subsystem 900 (FIG. 1) where the clinical simulations can be accessed by the target end users (i.e., healthcare students or practitioners). Applicants' COMPASS Architect subsystem 200 comprises computer readable program code encoded in one or more computer readable media encoding a series of data structures, such as and without limitation relational databases, flat files, HTML files, spreadsheet files, and the like, and user interfaces for Applicants' FAST-Faculty Assembler for Specifications and Templates module 300 (FIG. 1) that allow as shown in FIG. 1 setting parameters in Applicants':

1. MOLT—Mapping Ontology of Learning Templates module 400,
2. MALT—Multiattribute Assessment Latent-class Templates module 500,
3. Pathfinder—Adaptive Behavior Templates module 600, and
4. DATUM—Data Analysis Templates for Ultrastructure Mining module 700.

In some embodiments of the invention, there also are distinct interfaces for the MOLT, MALT, Pathfinder, and DATUM modules that allow setting of parameters that increase customization of templates for clinical simulations. Applicants' invention further comprises computer readable program code encoded in one or more computer readable media specific to each of the Pathfinder and DATUM modules (600 and 700 in FIG. 1) of the invention to analyze the collected data from end users (i.e., healthcare students and practitioners) in order make data-driven decisions for identifying misconceptions developed during learning, remediating misconceptions, and improving learning and competency outcomes of these end users. The analytical algorithms include statistical procedures for establishing sampling regimes of end users' choices as well as mapping and analyses of an end user's learning outcomes and competency performance within a clinical simulation.

To provide more detail for this preferred embodiment, we describe how an instructor uses components of the Applicants' COMPASS Architect subsystem 200 as an authoring system for simulations within a Virtual Clinical World. The method of the invention establishes the FAST module 300 (FIG. 1) as an authoring and management system, wherein that FAST module comprises a Faculty Assembler for Specifications and Templates. An instructor utilizes the FAST module to set parameters in four simulation modules: (1) MOLT module 400—Mapping Ontology of Learning Templates; (2) MALT module 500—Multiattribute Assessment Latent-class Templates; (3) Pathfinder module 600—Adaptive Behavior Templates; and (4) DATUM module 700—Data Analysis Templates for Ultrastructure Mining.

MOLT module 400.—This module receives input from Applicants' FAST module and configures a learning map template for a clinical simulation. The MOLT module searches a catalogue of databases that provide modular sets of educational goals, objectives, and learning activities related to developing clinical competencies in healthcare. As an instructor establishes parameters in Applicants' FAST module, instructions are received by MOLT to search for designated modular sets and then assemble a set of educational goals, and for each goal a set of learning objectives.

For each established objective, Applicants' MOLT module searches for and assembles a suite of learning activities. For each learning activity established, Applicants' MOLT module interfaces with Applicants' MALT module 500, wherein the MALT module searches for a suite of learning or competency assessments related to the respective learning activity. Applicants' MOLT module searches and queries a plurality of databases that associate educational goals, objectives, and learning activities.

Using Applicants' FAST module 300, an instructor can select one or more parameters related to choices of a theory of cognition and a theory of behavior change since different theories have different approaches to cognition or behavior change, respectively, each theory has specific models for learning goals, objectives, and learning activities, learning assessments for each learning activity, and diagnostic feedback for each learning assessment. Each theory also prescribes models for teaching different developmental stages of learners or different prior knowledge levels of learners. Consequently, each theory can be mapped to a type of instructional template and that template will be suitable for the type of course activity and the type of learner a particular instructor is teaching.

With choices for cognitive and behavioral change theories as well as for target learning audience selected, FAST can communicate a customized instructional template to both MOLT and MALT. The Applicant's MOLT module uses the instructional template to establish the linkages that collect and collate a specific set of learning goals, objectives, and learning activities consonant with the instructor's choice of theories of cognition and behavioral change and appropriate for a particular end user audience. The instructional template sent from FAST also allows automatically sets parameters for the MALT module and its learning-competency assessments as well as the respective diagnostic feedback data arrays for each assessment item. Subsequently the design of the MOLT module allows searching for and assemblage of the learning-competency assessments collated in MALT from the information in the instructional template that was selected by the instructor in FAST and based on a particular combination of cognitive and behavioral change theories. These learning-assessment competencies are then linked with their respective learning activities and become part of a learning map.

The learning map is completed as MOLT and MALT implement the information contained in the instructional template based on the instructor's selections using Applicants' FAST module. That learning map is operationally an assembly template that is implemented in a Virtual Clinical World module (see FIG. 1, 300, 400 to 800). This implementation can vary across embodiments of the invention, but in one preferred embodiment, the learning map assembly template is a hypervolume of linkages creating clinical simulations in the Virtual Clinical World. The hypervolume is populated by learning objects from Applicants' Learning Object Repository 810. Applicants' COMPASS Architect subsystem 200 employs search and mapping algorithms to locate the metadata or tagging of the learning objects, to select the tags that apply to specific template linkages, and then to populate the linkages to create the clinical simulations in the Virtual Clinical World.

MALT module 500.—The Multiattribute Assessment Latent-class Templates module comprises an array of algorithms, relational databases, and other databases that contain learning and competency assessment suites, along with the diagnostic feedback associated with each suite. Although MALT's capacities could be nested within MOLT, in some embodiments of the invention a separate MALT module allows instructors more flexibility to select learning-competency assessments that best meet the needs of a particular group of end users. MALT is constructed as a set of search algorithms and a searchable catalogue of modular sets of learning-competency assessments, with each set containing learning and competency assessments items that fall along a gradient from novice to expert in clinical care.

For example, in FAST an instructor might select a cognitive flexibility theory of cognition and a social cognitive theory of behavior change. The instructor also specifies in FAST the attributes target learner audience, including in some embodiments the developmental state or prior knowledge level of the learners. These theories and the attributes of the learning audience are tied to specific elements of instruction and FAST uses these theory and audience attribute choices to create an instructional template reflective of the elements of instruction consonant with both theories. This instructional template is grounded in a specific theory of cognition and a specific theory of behavior change, so the instructional template allows MOLT to select goals, objectives, and learning activities consonant with these theories. MOLT selects and collates goals, objectives, and learning activities.

Continuing this example, consider the case in which an instructor is developing a learning environment suitable for teaching basic physical examination to beginning (novice) nursing students. In FAST, the instructor has already selected theories of cognition and behavior change, which allowed FAST to create an instructional template. If the instructor is interested in teaching novice nursing students how to conduct a physical examination, within FAST this instructor also can set prior knowledge level. FAST creates the instructional template. This template informs MOLT of certain instructional element, but also informs MALT to assemble the respective learning assessments and diagnostic feedback elements. Consequently, MOLT assembles the learning goals and objectives as well as learning activities for novice nursing students who are about to learn how to conduct a physical examination. Simultaneously, MALT provides only a particular type of learning-competency assessment that is suitable for evaluating performance of beginning nursing students conducting a physical examination in a clinical simulation. In this embodiment, the separation of MOLT and MALT allows an instructor to select assessments more finely tuned to an end user's prior knowledge and skills levels. Furthermore, the flexibility of distinct MOLT and MALT modules would allow creation of different configurations of learning maps and assessments to provide different types and patterns of learning activities, learning assessments, and educational scaffolding specific to different cognitive and behavioral change theories.

Pathfinder module 600.—The Pathfinder module monitors end users as they work within a virtual clinical simulation. Pathfinder can be set within FAST to provide adaptive behavior and modification of the Virtual Clinical World in response to an end user's patterns of choices within the simulation. The Pathfinder module of Applicants' COMPASS Architect subsystem 200 responds to two real-world factors:

(1) users of a system and the system's designers often have different expectations about the system; and (2) different users may have different preferences for to how move through a system. Such differentials can be reflected in users having to perform “costly” tasks in order to reach their goal. By “costly tasks,” Applicants mean that the number of steps involved is large, or some subtasks are difficult to understand or perform. In addition, such differentials can be reflected in different users having different navigational and problem-solving strategies while working in a clinical simulation. In various embodiments of the invention, Pathfinder improves the end user's movement through a simulation by modifying the simulation based on inferred semantics.

As those skilled in the art will appreciate, a well-designed simulation avoids irrelevant and costly tasks, saves time to users, allows users' choices to shape navigational schema, and increases users' satisfaction. Applicants' Pathfinder module identifies usage patterns and mutates the Applicants' Virtual Clinical World in response to individual users' access patterns. In certain embodiments, Applicants' Pathfinder module assigns extra hyperlinks (called hotlinks) to simulation components.

The hotlink assignment process consists of a set of algorithms that are executed in three stages. The first stage uses the access logs of the simulation to infer user access's patterns. The second stage consists of building complex data structures that represent the hyperlink structure of the simulation. The third stage assigns hotlinks to the simulation in such a way that the most popular paths for an individual user or group of users become shorter and thus more accessible to users.

Applicants have discovered that, particularly in educational and training simulations within the Virtual Clinical World, it is desirable to provide a hotlink assignment algorithm to create mutations of a simulation based on the semantics dictated by user access patterns. Furthermore, in certain embodiments such virtual scenario mutations reflect important differences in users' preferences for working within the simulation and these preferences can be mapped against best practices in clinical decision making that allow performance evaluation of the end user in a clinical simulation.

In certain embodiments, a faculty member may want control over the degree of adaptive behavior of a simulation. Consequently, Applicants' FAST module allows enabling the Pathfinder module to impose the instructor's choice of degree of adaptive behavior and subsequent simulation mutation in response to an individual end user's or groups of end users' patterns of choice while working in the simulation.

The most important feature of Pathfinder, however, is that this Module collects data on the place where and how the learner is engaged within a virtual world or a simulation and how long the learner spends in each place. Additionally, Pathfinder records the outcomes of the learner's engagements with learning activities by collecting data on: (1) what an individual learns in a particular place during a particular time, as expressed within a cognitive taxonomy that be specified by the instructor within FAST and communicated to MALT; (2) how well that knowledge could be transferred either in that same place and time or in a later place and time within the virtual world; (3) the accuracy of clinical judgments and appropriateness of decisions made by the learner; (4) the behavioral intentions of the learner as well as the actual behaviors of the learners within the virtual world; (5) the use of diagnostic feedback and scaffolding to improve learning and the subsequent effectiveness of that use; and (6) metrics related to user satisfaction with the adaptivity and usability of the learning environment.

Pathfinder collects these data and links them at multiple levels of association. For example, a particular learning activity is nested within a collection of places, and a learner was engaged in these places, spending a certain amount of time in each place. Pathfinder would collect place-time data, data on the sequence of places visited by the learner, what the individual learned in these place based on learning outcomes assessments, the individual's behavioral intentions to act on the knowledge gained, the individual's clinical judgments and decisions made within the places, and the individual's rating of the usability of places visited. Pathfinder tags all of these data by place, time spent in the place, the moment in total time within the simulation at which the place was entered, the session in which the learning environment was used (e.g., in the event of multiple visits to the same learning environment), and other contextual data for which tags can be set within FAST. Such data and the tagging of these data by place-time attributes allow mapping of decisional sequelae that provide a way to follow cognitive processing and development of misconceptions.

DATUM module 700.—The DATUM module comprises a data collection and analysis engine for studying an individual or group of end users in regards to patterns of choices in a learning environment, as well as more complex mapping and mining of end user data related to learning-competency outcomes as complex functions of choices within simulations. As part of such learning competency outcomes, inadequate learning and misconception development can be delineated. Instructors using one preferred embodiment of the Applicants' invention would use Applicants' FAST module 300 (FIG. 1) to set cognitive and behavioral theory choices and then a sampling regimes for data collection consistent with the respective theories and the analyses of data collected. Applicants' DATUM module receives the sampling parameters established by an instructor, and creates Data Analysis Templates of Ultrastructure Mining. These templates establish the sampling and analysis of data resulting from end users' interactions within a clinical simulation in the Virtual Clinical World. Importantly, these templates also establish the sampling and analysis of end users' choices about moving through the Virtual Clinical World and the mutations implemented by the Pathfinder templates.

To provide a more specific example of one embodiment of the method, we examine how DATUM analyzes a decisional sequelae by an end user and how this place-time sequelae and associated learning outcomes provide insight into cognitive processing and misconception development, as well as how a specific adaptive mutation should be constructed to remediate inadequate knowledge in general and specific misconceptions in particular. At the start of this example, we note the six prior art deficiency factors mentioned above contribute to a general failure of prior art to collect sufficient and high quality data to follow both cognitive processing and delineation of misconception development. The result is both under-sampling of choices and outcomes of decisions made by a learner in an educational environment.

However, the Pathfinder module has collected real-time data streams on everything the learner did while in an educational environment, what learning outcomes the end user has achieved, and measures of the situated experience of the learner. Pathfinder has collected these data for each session in which the end user worked within the educational environment. These data arrays are available to DATUM. Furthermore, DATUM is guided by both the instructional design expressing a particular combination of cognitive and behavioral theories. DATUM also is guided by the focus of a query about end user learning and misconception development that an instructor or trainer has chosen for a particular educational intervention using the educational environment.

As a simplified use case, consider a student in a Fundamentals of Nursing course, a typical entry course for nursing students in BSN programs. Often, such a student would attend lecture-discussions sessions and also work online within a learning management instance (LMI) for the respective course. Within LMI, the student would engage in course modules. Within these course modules, the student would be provided with a variety of course assignments and resources, including assigned work within one embodiment of the Applicant's method. For this use case, suppose the student is learning six critical nursing skills, each available as a 1-hour interactive scenario within a Web-based educational environment built as one embodiment of the Applicant's method. In this use case, the student will engage in learning about each critical nursing skill and then complete a learning outcomes and knowledge transfer assessment within the educational environment system. Additionally, such a student will participate in a virtual Nursing Skills Lab, where she engages with low-fidelity and high-fidelity simulations to practice skills and where she is evaluated on her skills using a performance competency Skills Checklist embedded with the method embodiment.

The educational environment can be conceptualized as a suite of virtual places that are constructed for a student based on their Student Profile, created when they enter the COMPASS Gateway System. In each place, MOLT and MALT have assembled combinations of learning activities, learning resources, educational scaffolding, and learning outcomes assessments that have associated diagnostic feedback for each assessment item. The PathFinder engine can track where a student goes within the educational environment, and records a sequence of choices to engage in educational activities in a particular place within the Environment. Furthermore, Pathfinder attaches a time stamp to each place visited, calculating and recording time spent in each place visited. We earlier said these place-time data sets are the trace of a decisional sequela for the student and, in this use case, the trace for each 1-hour episode of engagement with a particular skill in the Educational Environment.

When the student completes a learning outcomes assessment within the educational environment, which measures conceptual competencies, the assessment items in the respective cells of the cognitive taxonomy of the assessment engine are placed within a conceptual competency analysis data array, which contains algorithms that map the respective conceptual competency to the places in the educational environment where there were learning activities and resources related to that conceptual competency. So, for some conceptual competency assessment item related to learning activities in place P1, there is an assessment score CC1. Analogously for knowledge transfer measures, there are conceptual competency transfer assessment items related to learning activities in a place. So, for place P1, there could be an assessment score related to knowledge transfer CCT1. The conceptual competency analytical data array creates the path linkages from where some conceptual competency could be learned (i.e., a place in the educational environment) to the conceptual competency learning outcomes from engaging in that place.

Additionally, when a student is assessed for a performance competency such as a skill implementation, there is a score on the Skills Checklist that is placed in a performance competency analytical data array. This analytical data array also has algorithms for mapping, and in this analytical data array the mapping connects a performance competency to places in the educational environment where the competency could have been learned. So, if there is a place P2 in the educational environment that covers a particular area of knowledge related to a specific skill, the performance competency measure PC2 would be mapped to that place in the respective performance competency analysis data array.

In one embodiment of the Applicant's method, these conceptual competency data arrays and the performance competency data arrays can be used to measure knowledge developed by the learner, the learner's capacities for knowledge transfer, and development of misconceptions by the learner.

1. Knowledge: After completing a scenario related to a particular skill, a student completes a learning outcomes assessment within eXAM3. Knowledge about each skill is measured by the set of {CCi} data summed across the places where learning activities related to the skill were found in the Educational Environment, so summing {CCi} for places Pi, i=1 to N. The DATUM has a submodule AssessMap that provides a summary of how well a student did in each cell of the cognitive taxonomy used, which can be set by an instructor. Applicants' AssessMap recites an assessment grid comprising a plurality of Performance Levels in combination with a plurality of Categories for each Performance Level. The AssessMap can be set to show how well a learner did in each cell of the cognitive taxonomy.

Applicants' method includes selecting a plurality of Performance Levels and a plurality of Categories, and assigning an assessment for each Performance Level and Category. A plurality of (N) Performance Levels and a plurality of (M) Categories comprises a total of (N) times (M) reported assessments.

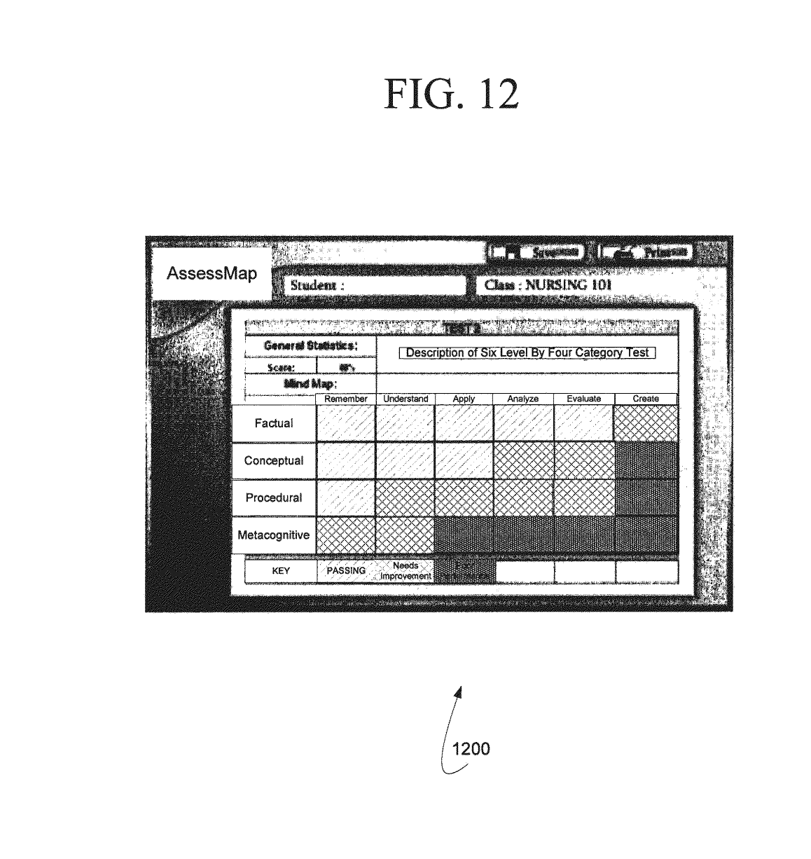

For example and referring to FIG. 12, in one embodiment AssessMap 1200 shows PASSING, Needs Improvement, and/or Poor Performance assessments indicating learning outcomes. In the illustrated embodiment of FIG. 12, Applicants' AssessMap reports results for a Six Level by Four Category assessment grid. In the illustrated embodiment of FIG. 12, the six levels include Remember, Understand, Apply, Analyze, Evaluate, and Create. In the illustrated embodiment of FIG. 12, the four levels include factual, conceptual, procedural, and metacognitive.

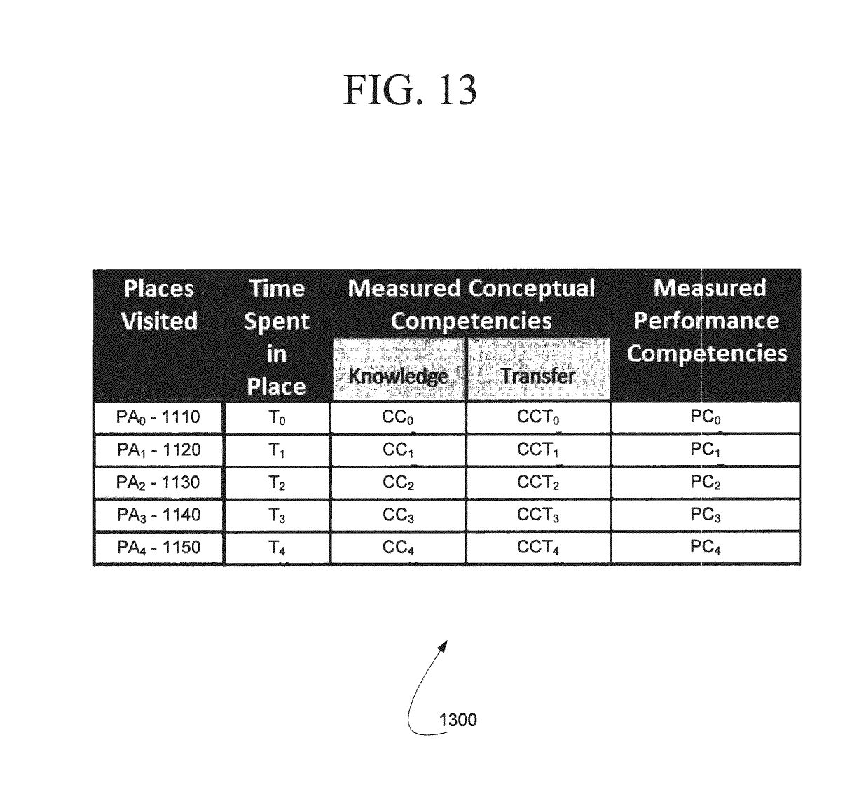

Referring to FIG. 13, a summary table 1300 provides detail on where skills knowledge was found within the educational environment and how well the student did on knowledge assessments related to each place where skills learning activities were located. In certain embodiments, Applicants' method creates a misconception analysis. By “misconception,” Applicants mean the state of a learner's unawareness that their knowledge domains and cognitive processing are incomplete or incorrect. Misconceptions comprise outcomes recited in Applicants' AssessMap as cells within the taxonomy indicating Levels/Categories that are assessed as “Needs Improvement” and/or “Poor Performance.

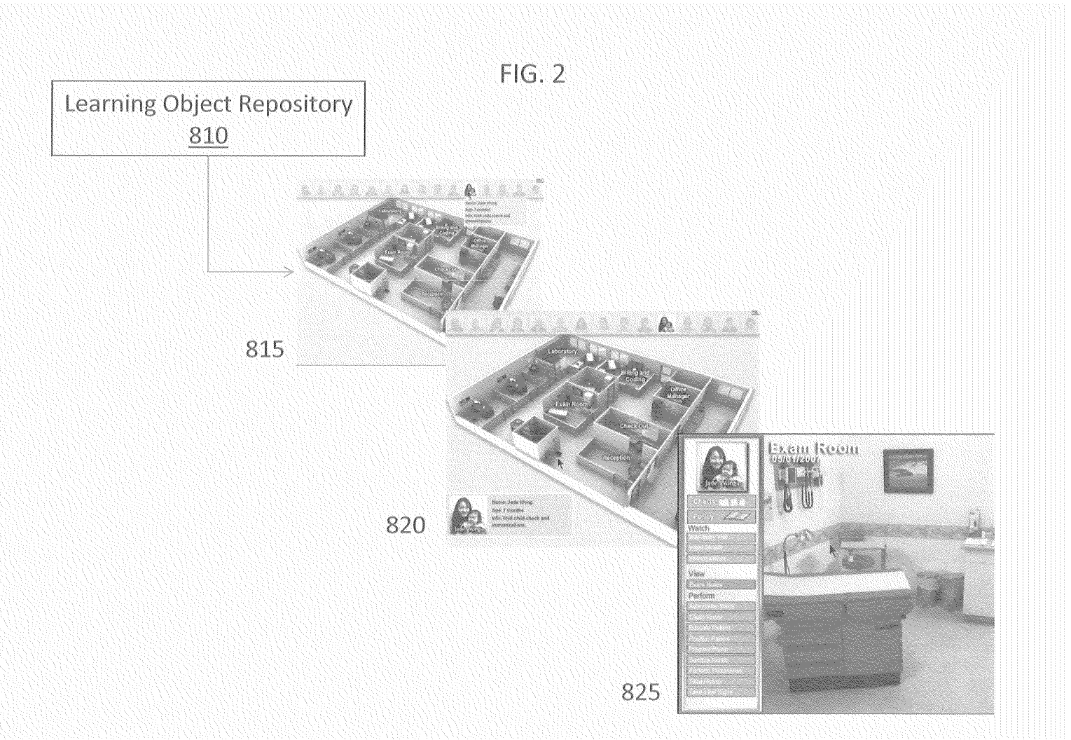

2. Knowledge Transfer: Each student completes a knowledge transfer assessment within the educational environment. Knowledge transfer related to each skill is measured by the set of {CCTi} data summed across the places where learning activities related to the skill were found in the Educational Environment, so summing {CCTi} for places Pi, i=1 to N. The AssessMap provides a summary of how well a student did in knowledge transfer assessments within each cell of the cognitive taxonomy chosen by the instructor. Again, the AssessMap can be set to reveal a variety of visual or numeric representation of results of learning outcomes. A summary table similar to FIG. 2 provides more detail on where skills knowledge was found within the Educational Environment and how well the student did on assessments related to each place where skills learning activities were located. Misconceptions are revealed by identifying outcomes in the AssessMap as assessment cells within the taxonomy indicating knowledge transfer was incorrect or incomplete.

3. Study of Misconception Development: During work to reduce the method to practice, we used these competency and performance analytical data arrays in one embodiment of the method to study misconception development in the follow ways.

(a) Similarity to Experts—These analyses embedded within the method use similarity indices (proportional similarity index and high odds ratio) or other statistical algorithms to analyze the similarity between students and clinical experts. Clinical experts indicate the places where essential learning activities were located. These similarity studies then use the place-time data and the algorithms of the analytical data arrays to develop maps for an end user and compare these maps to an expert clinician panel mapping.

(b) Unproductive Time—A second type of analysis uses the place-time data in the analytical data arrays to identify for each student the places experts did not believe to be productive for learning a skill. The method then calculates a percentage of time spent in the unproductive places within the educational environment (UP=Fraction of Time in Unproductive Places for Learning a Skill={time spent in places experts did not recommend/total time in the Educational Environment}).

c) Learning Path—In some embodiments of the method, a third type of automated analysis examines the place-time data as part of a decisional sequelae, which becomes a “Learning Map” of the end user's cognitive processing and choices within the educational environment. The different places along the sequela represent places where learning can take place. Common misconceptions can be identified by an expert panel or the instructor, who can use the FAST module to put tags on the places where these common misconceptions are most likely to be learned within the educational environment. The conceptual and performance competency analytical data arrays have additional algorithms that search for such tags. When these tags on places within the educational environment are identified, the analytical data array algorithms connect to the data of the CCi and/or CCTi scores. When such scores are at an unacceptable level, as set by an instructor within the FAST module, an alert is generated and combined with summaries of the learning outcomes and diagnostic feedback in ways that allow the end user to understand what misconceptions they have and how those misconceptions developed from incomplete knowledge gained during work within the educational environment.

In some embodiments of the Applicant's method there are options within the FAST module for setting up a variety of dashboards. These dashboards can be specified for individual end users of for the instructor to see both an individual as a well as a class or training group summary. For example, in one embodiment, a dashboard can be created that receives information feeds from the alerts that are part of the Learning Map, data on learning outcome from the knowledge and knowledge transfer AssessMaps, data from any type of Skills Checklist implemented by an instructor within the educational environment, data from usability and satisfaction measures implemented within the educational environment, and measures of behavioral intention implemented within the educational environment. The dashboard is created as a set of frames displaying summary versions of the data with annotations providing summary diagnostic feedback a well as hyperlinks to more detailed diagnostic feedback for the assessments and measurements collected within an educational environment on an individual or on a group of individuals.

The DATUM and Pathfinder modules connect and inform each other through submodules of knowledge subsystems that in some embodiments can evaluate and then implement an adaptive capacity to use different combinations of Learning Object that are still consonant with the selected instructional template but that may improve learning outcomes for the individual learner. This customization is based on how the learner used the educational environment and how they rated usability, satisfaction and satisfaction, as well as behavioral intent to engage in specific types of learning activities, learning resources, learning outcomes assessments, and diagnostic feedback and scaffolding presented to them in prior iteration of work within the educational environment. To summarize, and with reference to FIG. 1, within Applicants' COMPASS Architect subsystem 200, the FAST module 300 allows selection of a cognitive theory and a behavioral change theory. These selections result is FAST assemblage of an instructional grounded in a combination of theories. The instructional template creates four customized templates, one each from the MOLT module 400, the MALT module 500, the Pathfinder module 600, and the DATUM module 700. Applicants' MOLT module provides an educational framework of goals, objectives, and learning activities. Applicants' MALT module provides learning assessments for each learning activity in the MOLT template. Applicants' Pathfinder module establishes monitoring of an individual's choices and learning or skills outcomes within the educational environment, as well as adaptive learning capacities for the end user working in the simulations of the Virtual Clinical World. DATUM provides a variety of data analysis and interpretation templates that establish data collection and analysis frameworks for learning outcomes and adaptive behaviors of the end user working in the simulations of the Virtual Clinical World.

Applicants' four modules create a Virtual Clinical World 800 comprising clinical simulations. Applicants' four modules search for and link to learning objects in the Learning Object Repository 810. The Virtual Clinical World is then deployed within the COMPASS Gateway subsystem 900, which comprises a portal for end users to engage within the virtual world and its clinical simulations.

In FIG. 2 one embodiment of a Virtual Clinical World is partially portrayed. The MOLT, MALT, Pathfinder, and DATUM modules have linked to learning objects in the Learning Object Repository 810. In this example, the linkages build the Virtual Clinical World as an outpatient clinic 815, within which a patient can be selected 820, and the patient visited in any of several clinic rooms, such as an exam room 825. FAST would have been used to create a MOLT learning map, and educational goals, objectives, and learning activities would have been embedded in a MOLT module. The MOLT module would then have searched for these learning activities in the Learning Object Repository and assembled them as potential choices within the exam room in which a particular patient is nested.

In FIG. 2, a student/practitioner could choose to select any of a plurality of learning activities, and then follow that first choice by a series of choices of other learning activities. However, the sequence of learning activities demonstrating the best clinical judgment would have been selected by an instructor who used the FAST module to enable MALT to provide opportunities to demonstrate clinical judgment. MALT would search for and assemble good and poor choices for working with the virtual patient and would create a multiattribute latent class assessment environment within the Virtual Clinical World.

More specifically, there are multiple attributes of a particular clinical judgment that are latent (or hidden) to the student/practitioner. The student/practitioner must select from among essential and nonessential interactions with the patient and patient data, must correctly sequence activities, and must complete each activity with proficiency and demonstrate mastery of learning and skills outcomes or demonstrate a particular clinical competency.

Tracking the student/practitioner choices within a teaching-learning-assessment environment becomes critical. As the student/practitioner is working within the Virtual Clinical World and a particular simulation in that world, as shown in FIG. 2, Pathfinder is following the student's/practitioner's choices, including both place-time data. and data on the end user's learning outcomes as knowledge gained and capacities for knowledge transfer, and skills implementation, misconceptions developed, and perceptions of the learning environment. Such tracking allows a trace of the students/practitioner's movement through and engagement with various elements of a simulative environment. However, such tracking also can be used to create a more adaptive environment that adjusts the navigation in the Virtual Clinical World based on user preferences as demonstrated by prior choices in navigation and selection of learning activities, such as those shown in the navigation bar at the left of the GUI shown in the Virtual Clinical World exam room 825 as depicted in FIG. 2.

In certain embodiments, as in FIG. 2, the Virtual Clinical World is expressed as an environment created within a Flex application. For this embodiment, the Virtual Clinical World is accessed by the student/practitioner through the COMPASS Gateway which is connected to a learning management system hosted by an Educational Services Provider.

The Pathfinder suite of algorithms for this embodiment has compiled the Virtual Clinical World with embedded programming code in the Flex application. Pathfinder recognizes and uses the code to track the user's presence in some portion of the n-dimensional space of the Virtual Clinical World. As an example of a specific embodiment, consider a Flex application compiled to provide a Virtual Clinical World for training healthcare students in interprofessional care, which for this embodiment we will call IPSim and which is deployed in the learning management system of the Educational Services Provider hosting COMPASS. The path tracking functionality of the IPSim system is achievable within the FAST module as the instructor selects Pathfinder options and Pathfinder then automatically inserts program code within the IPSim Flex application. This code will collect data on certain variables (e.g., location in simulation, time spent in a location) and send these data to databases within the server of the Educational Services Provider. In this example embodiment, the embedded data gathering code in the IPSim grabs information based on the code's intent, for example, educational module accessed, current page or position in n-dimensional space, time spent in that space. Such code may be written as below in Actionscript:

//Creates a new update track event with IPSim variables
var updateTrackEvt:UpdateTrackEvent = new
UpdateTrackEvent(model.curModuleId.toString( ) +“_”+
curNavigationID.toString( ) +“_”+
curPage.attribute(“id”).toString( ), model.currSession);

This type of code shown above creates an object and then this object is dispatched to a data collating functionality in the server of the Educational Services Provider. In this embodiment, the data collating functionality captures the data sent by the code within the Flex application educational simulation as a student/practitioner is working within a particular part of this simulation. In this embodiment, the server of the Educational Services Provider would then organize the data for database functionality. A portion of such coding is shown below:

```
  //Stores up UID
$uid = $_REQUEST[‘UID’];
//Build table name with uid and session number
  $table = “uid”.$uid.“sn”.$_REQUEST[‘curSession’];
```

In this embodiment, the data collating functionality in the server then builds a SQL query entry with the obtained data and inserts these data as new database row entry, suggested by a portion of code shown below:

$insert = “INSERT INTO “.$table.” VALUES
(‘“.$_REQUEST[‘PID’].”’,CURRENT_TIMESTAMP(0));”;

Additional coding establishes connection between the data collation functionality in the server and the database functionality in the server. Once the connection is established, code inserts the data into the database.

The embodiment described above is a simple example. A unique and unobvious facet of the COMPASS Architect subsystem is that the applicants use Model-driven Software Engineering to create multiple Domain Specification Languages (DSLs). These DSLs can be built for a large number of different types of simulative educational environments and become the foundation for the templates described for MOLT, MALT, Pathfinder, and DATUM modules. For the Pathfinder module, the DSLs provide multiple simulative environments with the most appropriate embedded tracking codes for the respective environment. Consequently, the Pathfinder templates represent a catalogue of different tracking patterns that are mapped to the templates for MOLT, MALT, DATUM, and so used to compile the Virtual Clinical World Module.

Thus, the Pathfinder module allows the option to track a student's/practitioner's movement through a simulative environment and study that movement in the context of the each individual's performance on the MALT learning assessments. Additionally, the Pathfinder in communication with the Datum module has an option to engage adaptive behavior functionality for the learning environment so that the environment adapts to an end user's preferences, with embedded tracking codes adjusting for a mutation in the navigational schema.

Simultaneously with Pathfinder tracking of a student's practitioner's engagement in learning activities within any part of a simulative environment, DATUM is following and recording both learning-competency assessment outcomes during student/practitioner interactions with simulated patients and patient data as well as following and recording Pathfinder's delineation of usage patterns and mutations of navigation to match these patterns. The parameters governing Pathfinder and DATUM were set by the instructor in the FAST module.

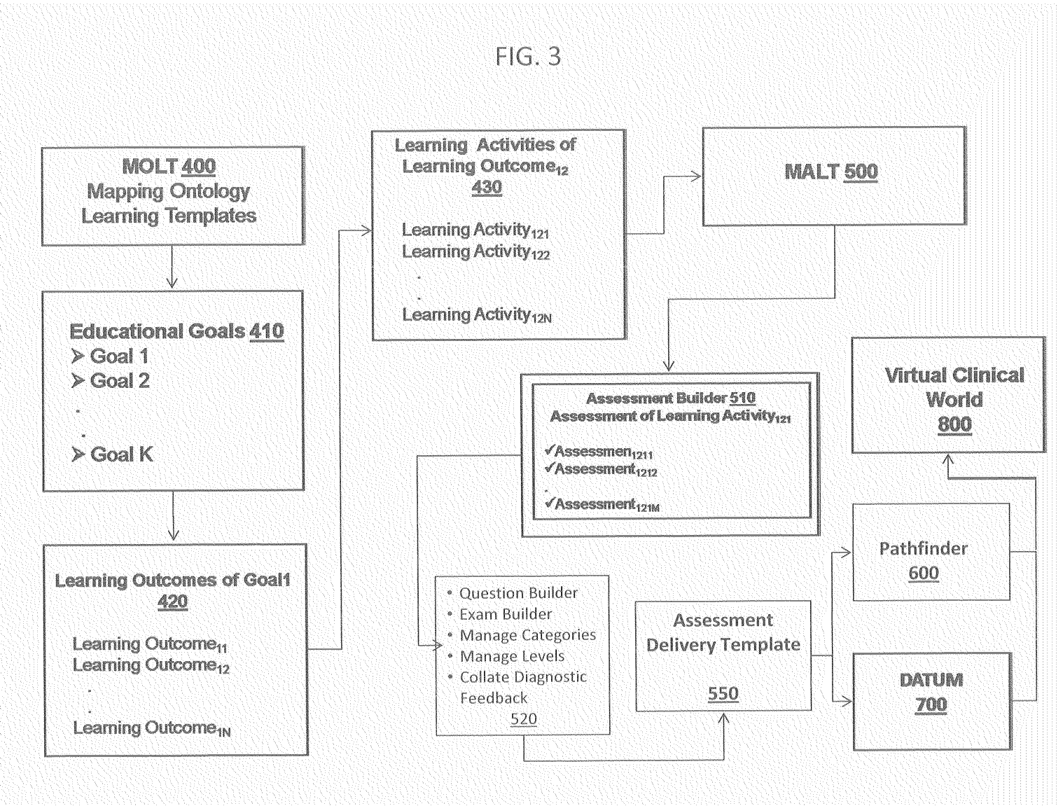

FIG. 3 illustrates an instructor working within the COMPASS Architect subsystem 200. Applicants' FAST module comprises an authoring and management system to define the templates that will create the Virtual Clinical World and how that world will behave in response to student or practitioner choices within the clinical simulations of that world. FIG. 3 shows the MOLT module 400 being accessed and educational goals chosen by the instructor 410. For each education goal, a set of learning outcomes 420 are selected and for each outcome a suite of learning activities 430. Such choices create a MOLT learning map template, with choices by the instructor based on the specific educational needs of or training program designed for a target group of end users.

The MOLT module also maps learning-competency assessments required for each learning activity into the MALT module 500. Then, the instructor would use FAST to select particular learning-competency assessment items or clusters to create a MALT template. From the metadata or tagging of learning activities, their associated learning-competency assessments are collated for the instructor. Because the assessment items range in suitability from novice to expert, the instructor sorts the assessment items by level of prior knowledge and skill, choosing those assessment items most suitable for the particular student/practitioner. The instructor selects assessment items for each learning activity using the Assessment Builder 510. These items are then loaded into a MALT functionality 520 that establishes a cognitive taxonomy for the assessment items, as chosen by the instructor or staff trainer. In addition MALT establishes from the suite of assessment items a mapping to detailed item-specific feedback arrays for each item that will be available to the student/practitioner after they complete a learning assessment. Assessment items and their respective diagnostics feedback arrays are then placed into the Assessment Delivery Template 550 that interfaces with the Virtual Clinical World and simulations are deployed.

In the illustrated embodiment of FIG. 3, the MALT module is integrated with the Pathfinder 600 and the DATUM 700 modules. The metadata and tagging of the selected assessment items allows a mapping into the DATUM module 700 and allows the instructor to set the types of data collection and analyses of the learning-competency assessments desired for the respective student/practitioner audience.

The MALT module also interfaces with the Pathfinder module 600 providing the information from both MALT and MOLT on the levels of navigation within the simulations of the Virtual Clinical World. Instructor choices within FAST establish the MOLT, MALT, Pathfinder, and DATUM templates. These templates then create the substantive choices available in the Virtual Clinical World 800. This process allows an instructor to create clinical simulations within a Virtual Clinical World that have been customized by the faculty member or staff educator for any individual student/practitioner or to any group of students or group of practitioners.

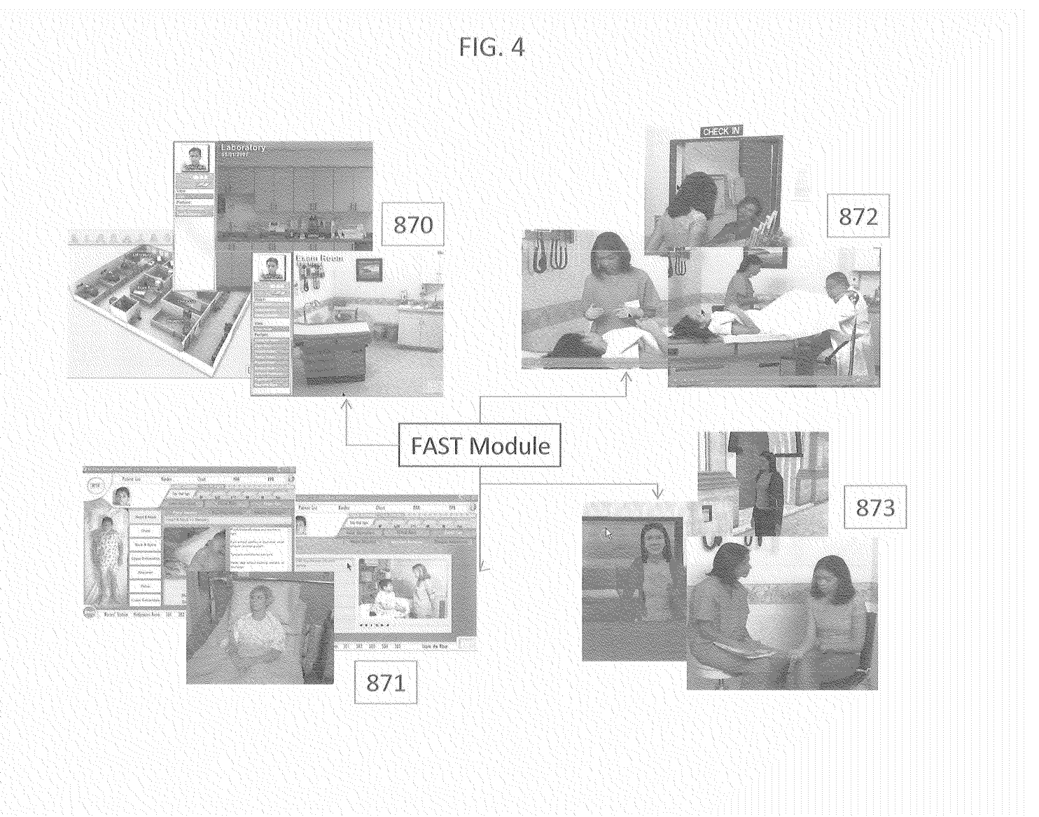

FIG. 4 illustrates different instructor choices in one embodiment for the FAST module to create multiple clinical simulations (870, 871, 872, and 873). A unique and unobvious feature of this capacity is that the FAST module in combination with a diverse Learning Object Repository can be used to create simulations with interfaces linked to the learning activities and learning-competency assessments (870, 871) that provide a variety of navigational levels as well as patient-end user interactions that include interactive video, text, images, and so on. However, FAST and a diverse Learning Object Repository can also be used to create 3-dimensional simulations wherein the student/practitioner moves, encountering and caring for simulated patient (872, 873).

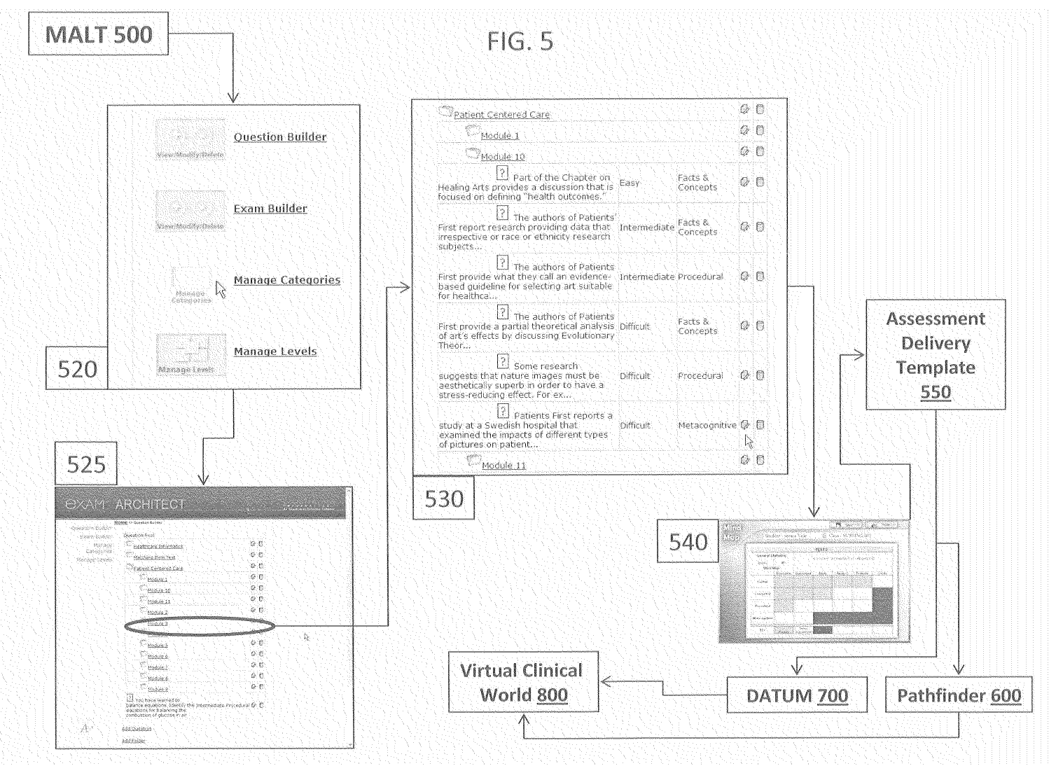

FIG. 5 illustrates elements of MALT module in one embodiment of Applicants' invention. FIG. 5 illustrates use of Applicants' FAST module to select particular learning-competency assessment items or clusters to create a MALT template. Applicants' MALT module has an Assessment Builder and within this Builder there is an element 520 that provides an authoring interface that allows an instructor to build assessment items as well as combine these items into learning-competency assessments. In the authoring interface 525 through 540, as depicted in FIG. 5, an instructor codes assessment items by Category and Levels, which allow creation of a knowledge or skills-based taxonomy for any learning-competency assessment. The Categories and Levels can be chosen and modified by the instructor or staff educator by selection of parameters to allow expression of the teaching-learning-assessment environment within the framework of an of the dominant theories of cognition and/or dominant theories of behavioral change.

Within the authoring interface MALT 520 an instructor can access libraries of folders containing assessment items 525 and within each folder locate specific sets of assessment items 530. For each assessment item, an instructor can select or create a learning object associated with the respective item as well as detailed feedback for an end user. The feedback to end users includes but is not limited to: (1) information about why one or more responses were correct but others were not; (2) possible clinical or patient-care implications of not responding correctly to the respective assessment item; (3) learning resources to help the student/practitioner better understand the topics being assessed for learning mastery or competency demonstration; (4) the rationale for use of learning objects nested within an assessment item; (5) diagnostic information on strategies for working within the Virtual Clinical World; and (6) learning resources to help improve the student's/practitioner's understanding of clinical competencies explored within the Virtual Clinical World.

From the metadata or tagging of learning activities in MOLT 400, associated learning-competency assessments are automatically collated in MALT (500 to 540 in FIG. 5) by an instructor setting parameters in MALT. Because the assessment items in MALT range in suitability across the gradient of users from novice to expert, the MALT authoring and management capacities allow the instructor to sort the assessment items by level of prior knowledge and skill, choosing those assessment items most suitable for the target student/practitioner, and organizing those assessment items into an assessment taxonomy. Again, such flexibility allows a faculty member or staff educator to use a preferred theory of cognition or behavioral change as a model for the educational framework expressed in the educational simulations with their respective learning activities, learning resources, and learning assessments.

In so doing, the instructor associates assessment items for a learning-competency assessment, mapped directly to the learning activities chosen within MOLT, and tied to a diagnostic taxonomy that shows results of performance on the learning-competency assessment as well as providing diagnostic feedback to the student/practitioner in a taxonomic framework 540 selected by the instructor. Referring once again to FIG. 3, Applicants' MOLT module 400 and MALT module elements 520-540 then each become a template added to the Assessment Delivery Template 550 in FIG. 5, which in turn feeds information to the Pathfinder 600 template and the DATUM 700 template. MOLT, MALT, Pathfinder, and DATUM then provide the algorithms and linkages to create a Virtual Clinical World 800.

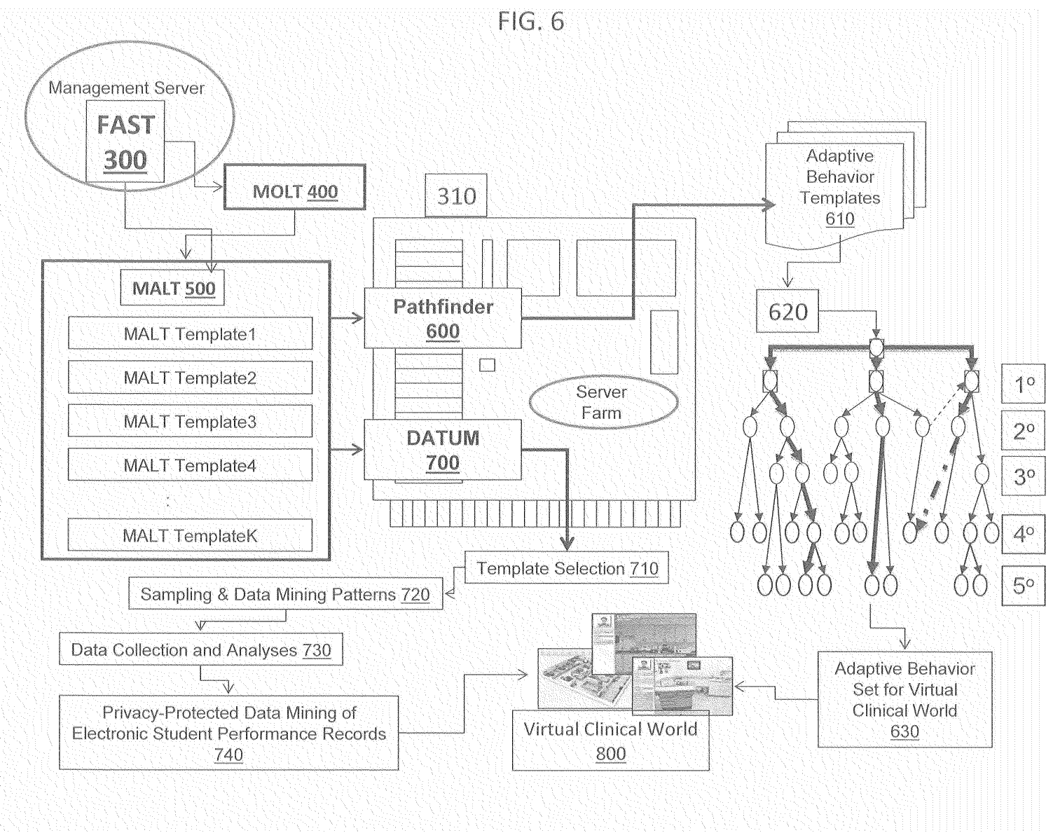

FIG. 6 illustrates how an instructor would work on the FAST module 300, engaging to set parameters in MOLT module 400 and MALT module 500. Such settings establish the learning map in MOLT and the learning-competency assessments in MALT. In MALT 500, we see MALT Templates, which comprise the information and algorithms necessary to create individual assessment items and to assemble the assessment items into a learning-competency assessment. The MOLT 400 learning map template and a MALT 500 template for a learning-competency assessment are then coupled to the Pathfinder 600 and DATUM 700 components. As shown in the embodiment of the invention represented by FIG. 6, FAST, MOLT, MALT, Pathfinder, and DATUM modules could reside in a single server or in connected servers organized in ways that permit a Virtual Clinical World to be loaded with learning objects from the Learning Object Repository in the Applicants' COMPASS Architect subsystem 200 (see FIG. 1). The assemblage of these learning objects as directed by the algorithms of the MOLT, MALT, Pathfinder, and DATUM modules creates clinical simulations comprising Applicants Virtual Clinical World. The clinical simulations of the Virtual Clinical World can then be deployed from the COMPASS Gateway subsystem 900. Students/practitioners access the Gateway 900 through Web-based systems such as learning management systems or dedicated Websites.

Furthermore, and as shown in FIG. 6 for one preferred embodiment of the Applicants' invention, the instructor can select parameter settings in the Pathfinder module 600 and thereby establish the characteristics of the adaptive response of Applicants' COMPASS Architect subsystem to student/practitioner patterns of choices within the clinical simulations of the Virtual Clinical World. These selections by an instructor create the Adaptive Behavior Templates 610 which then establishes the ability of Applicants' COMPASS Architect subsystem to monitor student/practitioner choices and adjust the clinical simulations. In some preferred embodiments of the invention, the monitoring and adjustment is implemented for each individual student/practitioner. However, other embodiments of the invention allow settings for individual students/practitioners, for subsets of the student/practitioner population for a particular set of clinical simulations, or for the entire population for a particular set of clinical simulations.

FIG. 6 illustrates Adaptive Behavior Template 610 which delineates a set of pathways and navigational schema 620. These pathways and navigational schema are based on the MOLT learning map as created by an instructor in FAST. The template for monitoring and adjustment then establishes the Adaptive Behavior Set 630, which is loaded into the Virtual Clinical World 800.

In one of the preferred embodiments and as shown in FIG. 6, an instructor will set the parameters of the DATUM component 700. The instructor's choices in FAST allow selection of a template 710 from within an array of algorithm suites for data collection and analysis. Applicants' data collection and analytical algorithms comprise capacities for setting sampling regimes for sampling end users' choices within a simulation as well as numerous types of statistical procedures that provide mapping and analyses of student/practitioner learning outcomes and competency performance within a clinical simulation.

The template selection sets Sampling and Data Mining Patterns 720. The Sampling and Data. Mining Patterns establish patterns of Data Collection and Analysis 730 of data from students/practitioners as they work within the clinical simulations created in the Virtual Clinical World. The DATUM module is further modified by the instructor working in FAST so that an element of DATUM called Privacy-Protected Data Mining 740 allows privacy layers may be placed around the data mining of student/practitioner performance data and analyses of such data. The DATUM template then is combined with the MOLT, MALT, and Pathfinder modules such that the templates generated become the organizing principles for the Virtual Clinical World 800. The templates drive construction of clinical simulations within the Virtual Clinical World by searching for and assembling the learning objects from the Learning Object Repository that map onto the parameters set by the instructor within FAST.

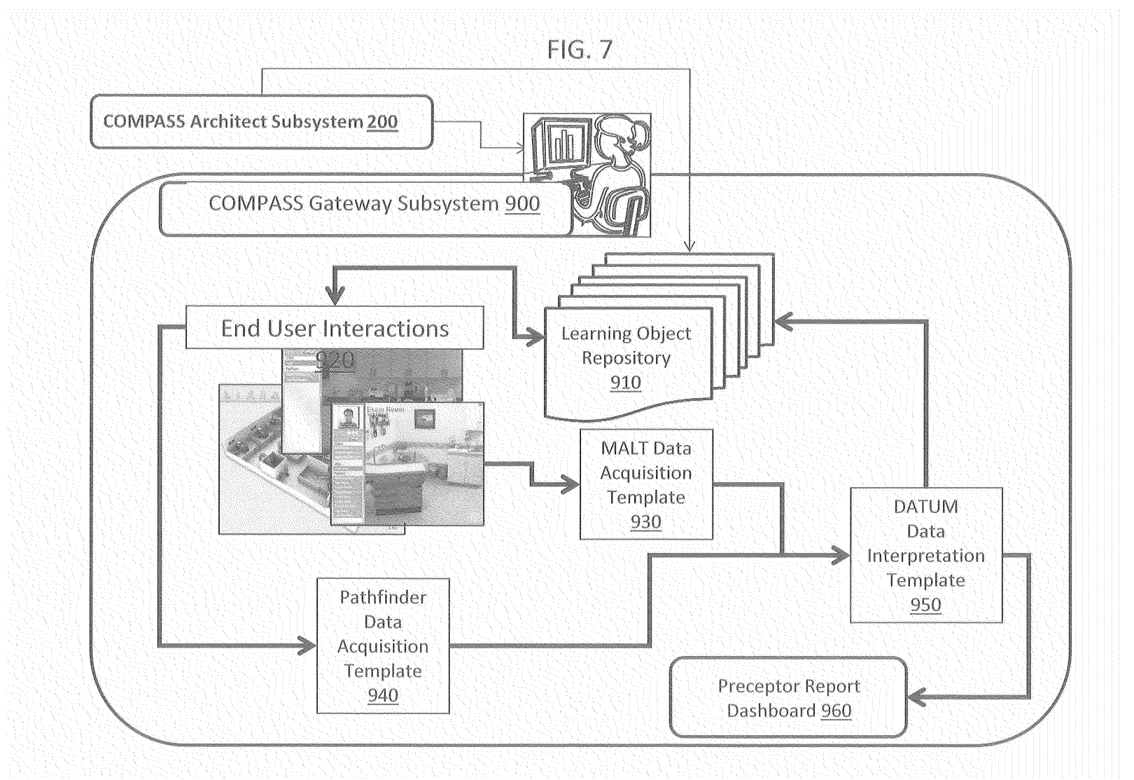

In a preferred embodiment of the invention, an instructor creates a customized Virtual Clinical World that is then deployed through the COMPASS Gateway subsystem 900, as depicted in FIG. 7, which illustrates a diagrammatic representation of this deployment. Applicants' COMPASS Architect subsystem 200 interconnects to the COMPASS Gateway subsystem 900, and a student/practitioner utilizes a computing device that accesses the Gateway 900. Applicants' COMPASS Architect subsystem 200 also opens a linkage between COMPASS Gateway subsystem 900 and Learning Object Repository (200 to 910 in FIG. 7) because the MALT module may comprise assessment items that use some of the learning objects that have not been loaded into the clinical simulations but exist in the Repository. The student/practitioner then can access and work within the clinical simulations of the Virtual Clinical World 920. Within the COMPASS Gateway subsystem, there are components that gather data on student/practitioner choices. One of these components is the MALT Data Acquisition Template 930. This template monitors the assessment items of the learning-competency assessment established by MALT and loaded into the Virtual Clinical World along with learning objects used in the assessment items but not found in the clinical simulations of the virtual world. As a student/practitioner encounters, engages with, and responds to assessment items, a performance record is maintained and sent to a second COMPASS Gateway component, the DATUM Data Interpretation Template 950. The DATUM Interpretation Template analyzes the performance record and creates the diagnostic feedback from the information provided by MALT.

A third component nested in the COMPASS Gateway subsystem as shown in FIG. 7 is the Pathfinder Data Acquisition Template 940. This Pathfinder template monitors student/practitioner navigational choices and selection sequences for engaging with simulation learning activities. This template streams data to conceptual and performance analytical data arrays. The data arrays with their embedded algorithms connect to the DATUM module and together provide analysis of these choices, places them into a sequence representing a map of the end user's choices, and uses weighted probability of place-time mapping. Such place-time mapping is combined with learning outcomes data, data on misconception development, and end user perceptions of usability satisfaction, and behavioral intentions to create dashboards that give the end user and the instructor or staff trainer detailed information on the learning processes of the end user. Additionally, these data can be used to reconfigure the simulation navigation and learning activities to fit student/practitioner patterns and preferences for learning as modified by suggestions for patterns likely to optimize learning and reduce misconceptions.

The capacities for such analyses and mutations are built into the algorithms of the Pathfinder Adaptive Behavior Set that was used to construct the Virtual Clinical World (see FIG. 6 pathway from 610 to 800). The Pathfinder Data Acquisition Template 940 in the COMPASS Gateway subsystem diagram shown in FIG. 7 also sends data to the DATUM Data Interpretation Templates 950. Such Pathfinder data are analyzed with this module and in combination with analysis tools in the DATUM module. A plurality of analytical methods are available, depending on embodiments, but can include data mining methodologies that examine complex relationships between an end user's leaning-competency performance outcomes and that respective end user's navigational and sequence choices within the simulations.

The DATUM Data Interpretation template 950 receives data streams from both the MALT Data Acquisition Template 930 and the Pathfinder Data Acquisition Template 940. After analyses, the DATUM module feeds information about an end user's performances within a simulation to a Preceptor Report Dashboard 960. This dashboard provides summary and diagnostic information on learning and competency outcomes to the end user.

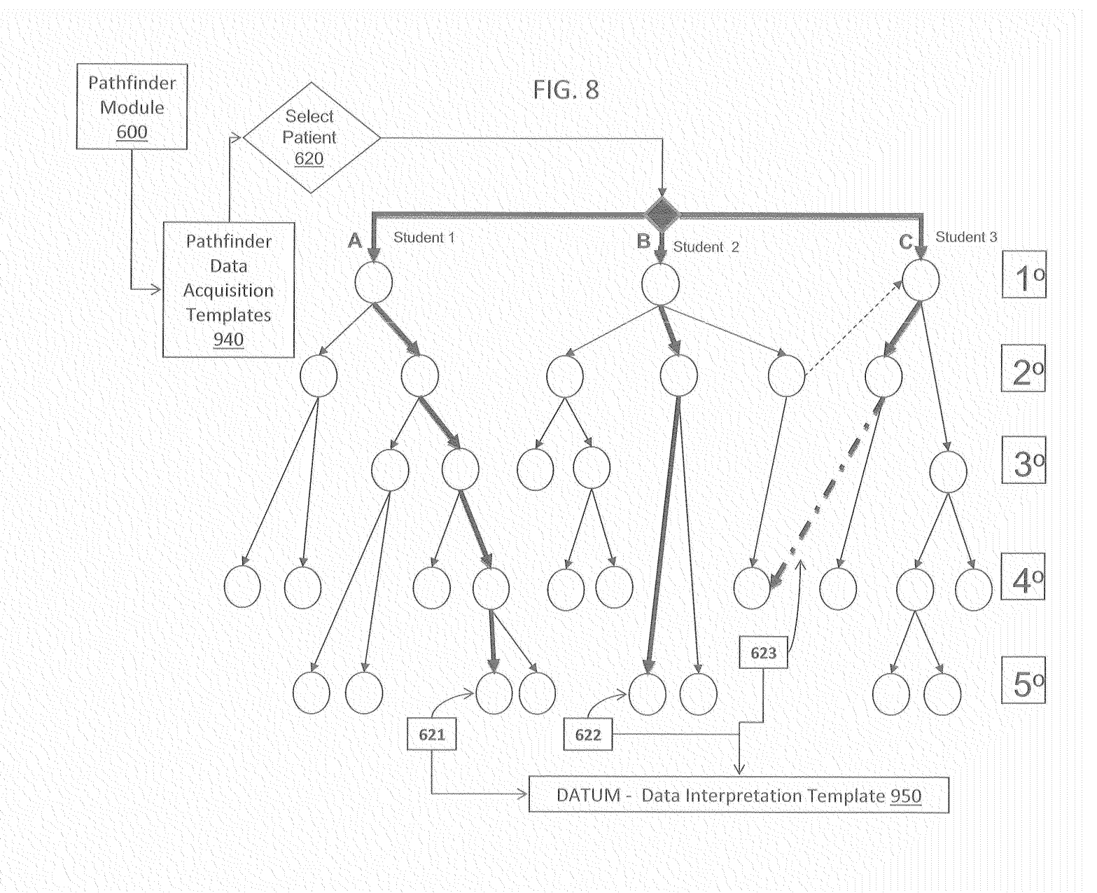

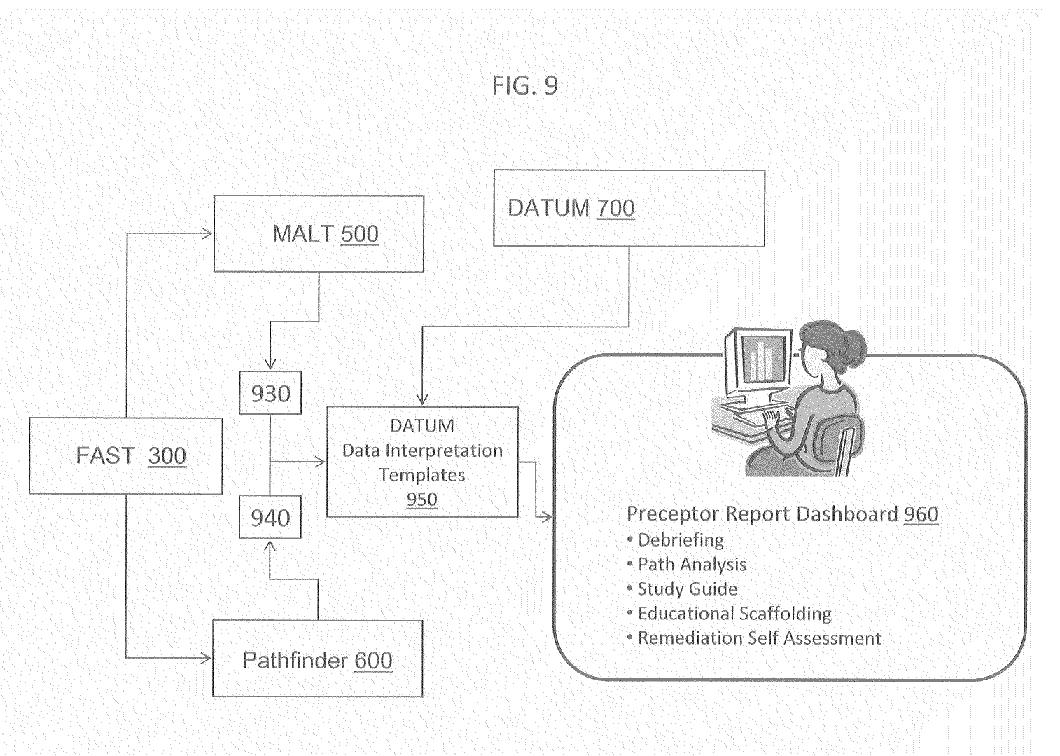

FIGS. 8 and 9 illustrate Applicants' COMPASS Architect subsystem 200 providing teaching, learning, learning assessment, and research capacities. FIG. 8 illustrates Pathfinder module 600 monitoring different end user's choices through a clinical simulation. FIG. 8 shows three Healthcare students interacting with a virtual patient within a clinical simulation. Once a patient has been selected, there are three available pathways a student could follow, A-C. Each of these pathways has five levels of navigation (10-50, in FIG. 8). Student1 selects pathway A 621. Student2 selects pathway B 622. And, Student3 selects pathway C 623, with a crossover to pathway B. Pathfinder module 600 monitors each student and records usage patterns within the simulation. After a student works within a simulation a few times, Pathfinder reconfigures the simulation and navigation to meet usage pattern preferences of each student. Such reconfiguration or adjustment is mapped to a student identifier and when prompted or when a student subsequently re-enters the Virtual Clinical World the simulation will adapt to that student's usage patterns.

However, although adaptive learning has many advantages, one disadvantage is that an end user may select a pattern of usage that is maladaptive for developing the higher order reasoning necessary for certain types of learning and competency outcomes. High resolution diagnostics for students/practitioners in a computer-implemented learning environment have been difficult to develop in educational materials, as evidenced by deficiencies in the prior art. Applicants' COMPASS Architect and Gateway subsystems combine data collection and analyses of end users' choices with data collection and analyses of student's/practitioner's learning and competency outcomes, including delineation of the process of an individual's development of misconceptions. As depicted in FIGS. 7 & 8, end user data from the Pathfinder Data Acquisition template 940 (FIGS. 7 & 8) flow into the DATUM Data. Interpretation template 950 (FIGS. 7 & 8). Because of the complexity of exploring relationships between choices made within a clinical simulation and learning-competency outcomes, the DATUM module provides broader and deeper data mining and analytical frameworks for studying such complexity.

FIG. 9 provides a diagrammatic representation of how:

1. Parameters for MALT module 500 and Pathfinder module 600 are set through the FAST module 300 to create templates that become organizing algorithms for a Virtual Clinical World.

2. Parameters for the DATUM module 700 are set through the FAST module 300 to become a template of organizing algorithms for data analysis of end users' choices and performances within the Virtual Clinical World.

3. Applicants' COMPASS Architect subsystem 200 comprises a DATUM element DATUM Data Interpretation Template 950, which handles the data analysis of student's/practitioner's choices and performances within the Virtual Clinical World.

4. MALT Data. Acquisition Template 930 and the Pathfinder Data Acquisition Template 940 direct collection of data from a student/practitioner using the COMPASS Gateway subsystem and stream these data to the DATUM Data Interpretation Template 950.

5. The DATUM Data. Interpretation Template 950 sends information to the Preceptor Report Dashboard 960 within COMPASS Gateway subsystem. This dashboard provides high resolution, detailed feedback and educational scaffolding to support improved learning and competency outcomes by end users.

6. The Preceptor Report Dashboard 960 within the COMPASS Gateway subsystem provides a variety of support options, including but not limited to:

a. detailed debriefing for end users;
b. analysis of the paths taken through simulations and the sequences of encounters and engagement with learning activities;
c. a study guide that provides diagnosis of performances on learning outcomes assessments as well as on competency demonstration assessments;
d. delineation of the end user's learning process that led to misconceptions;
e. educational scaffolding to help end users find leaning resources related to the learning activities; and
f. suites of remediation and self assessment tools to help end users improve conceptual and performance competencies while reducing misconceptions while learning within the simulations.

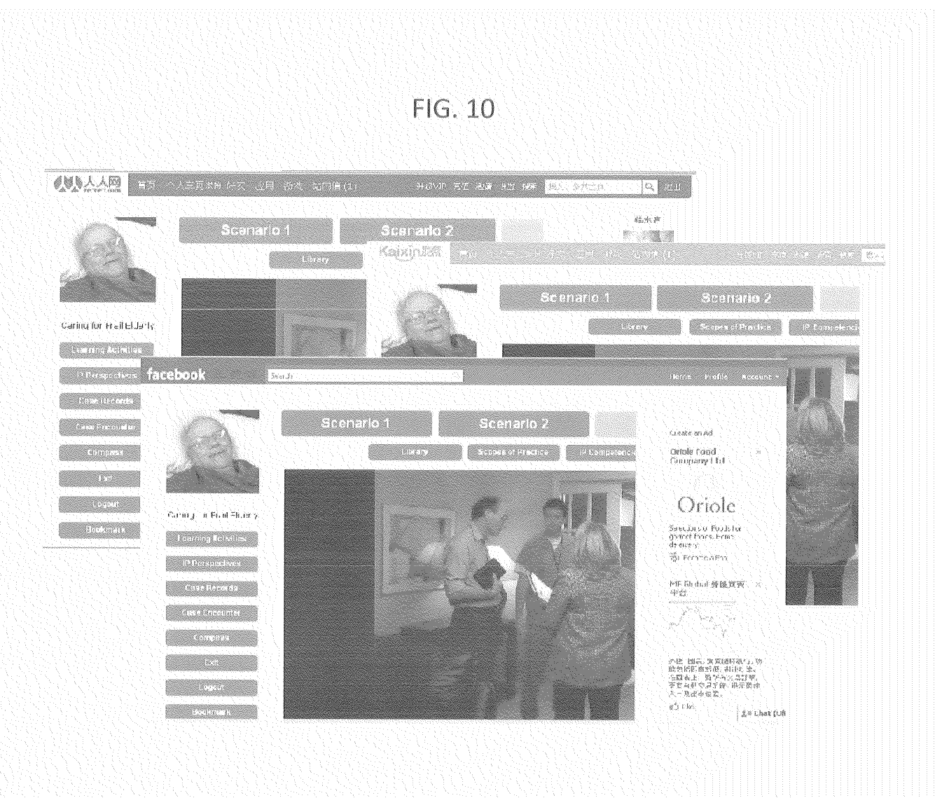

FIG. 10 provides an example of three embodiments of the Applicants' method in which a Virtual Clinical World has been complied and nested within a social networking environment on the Web. In FIG. 10, three social networking systems are shown with an example of a Virtual Clinical World nested within each. The graphic user interface (GUI) in the foreground shows a Virtual Clinical World nested within “facebook” environment. The GUI in the middle shows a Virtual Clinical World nested within “Kaixin,” while the GUI in the background shows a Virtual Clinical World nested within “Renren.” Since users in mainland China were blocked from using “facebook,” two Chinese corporations have partnered to produce “Renren” and “Kaixin” to provide social networking environments with much the same functionality as “facebook.” In the embodiments shown in FIG. 10, the teaching-learning-assessment activities of the Applicants' method can be sensibly nested within social learning environments manifest within social networking capacities of “facebook,” “Renren,” and “Kaixin,” but the important point is that the Applicants' method provides the flexible customization of competency assessment environments for healthcare students/practitioners in a diverse array of embodiments.

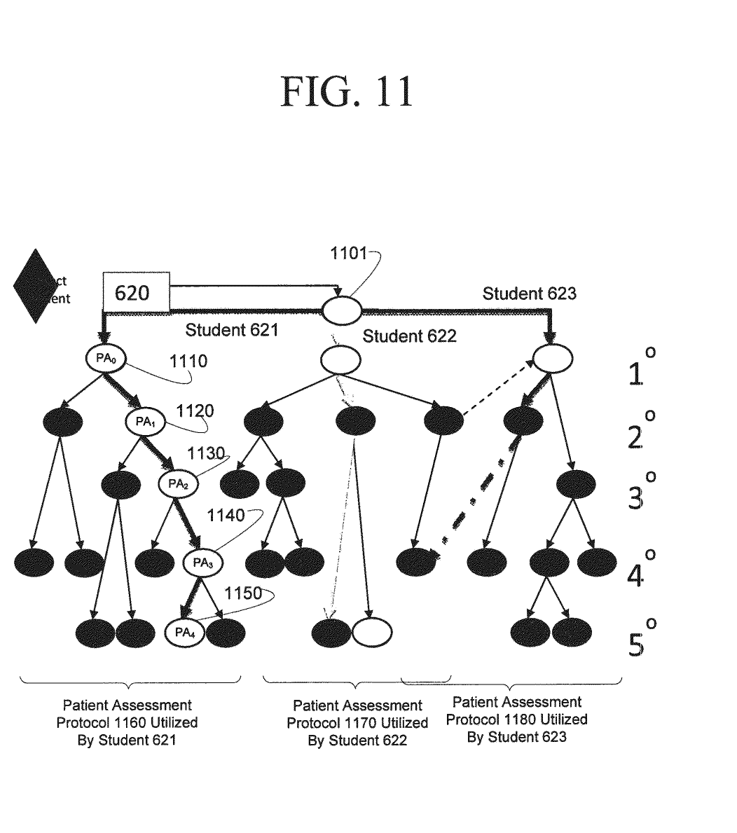

FIG. 11 provides a diagrammatic representation of the mapping of Pathfinder data streams into conceptual and performance competency analytical data arrays that are also accessed by DATUM. The Pathfinder Data Acquisition Templates 940 have algorithms that monitor an individual's engagement within the educational environment. In FIG. 11, three students, namely students 621, 622, and 623, each assess the same patient 1101. In the illustrated embodiment of FIG. 11, each student elects to utilize a different patient assessment protocol.

Referring to FIGS. 11 and 13, Student 621 has a pathway of places and times in each place through the educational environment utilizing a plurality of Patient Assessment (“PA”) interactions with a selected virtual patient. In the illustrated embodiments of FIGS. 11 and 13, Student 621 transitions from PA₀ to PA₁ to PA₂ to PA₃ to PA₄, with time spent in each place respectively T₀, T₁, T₂, T₃, and T₄, for a particular session of working within the environment. As the student moves within the environment the Data Acquisition Templates are recording data on place and time spent in each place of the educational environment and creating conceptual and performance competency analytical data arrays 945. DATUM also is activated creating Data Interpretation Templates 950, which provide analyses and interpretation based on choices made by an instructor in the FAST module.

In each place within the educational environment there are learning activities, learning resources, learning outcome assessments, and diagnostic suites associated with each learning outcome assessment. Consequently, a student can engage with these activities, resources, and assessments within each place. The learning outcomes assessments are handled by the AssessMap subsystem of FIG. 12. Data from Applicants' AssessMap also streams into the analytical data arrays. The AssessMap subsystem provides assessments of conceptual competencies, including knowledge gained and capacities for knowledge transfer. The AssessMap subsystem also can assess performance competencies.

Referring now to FIGS. 11, 12, and 13, Student 621 spends a quantum of time T1 at a place such as PA₁, and there can be a measure of knowledge gained as a conceptual competency (CC₁) as well as a conceptual competency measured as a capacity for knowledge transfer (CCT₁). There are also assessments of performance competencies, PCi, so in place PA₁ there is a measure of performance competencies in that place, (PA₁). The analytical data arrays have their own algorithms that provide some analysis of knowledge gained, knowledge transfer, and delineation of misconceptions, mapping these to each place in which the student engaged. Obviously, the student could be a pre-professional healthcare student or a practicing clinician.

As discussed above and shown diagrammatically in FIGS. 7-10, the PathFinder Data Acquisition Template 940 and the DATUM Data Interpretation Template are coupled for analysis and interpretation. As shown in FIGS. 7 and 9, the DATUM Data Interpretation Template provides information to the Preceptor Report Dashboard 960, which also can send information to individual specific dashboards or to group-specific (e.g., class, training group, and so on) dashboards.

Additionally, in some embodiments of the Applicant's method in each place there are probes of the end user's satisfaction, perceptions of usability, and behavioral attentions to learn within the place. These probes are measurements that also provide data, and these data streams also can be collected within the analytical data arrays (for simplicity sake, not shown in FIG. 11).

In certain embodiments, Applicants' invention includes computer readable program code comprising instructions residing in one or more computer readable media, wherein those instructions are executed by one or more processors to implement Applicants' modules and methods as described and claimed herein.

In other embodiments, Applicants' invention includes computer readable program code comprising instructions residing in any other computer program product, where those instructions are executed by one or more computing devices external to, or internal to, Applicants' server farm 310 (FIG. 6) or Management Server contain FAST 300 (FIG. 6), to implement Applicants' modules and methods as described and claimed herein. In either case, the instructions may be encoded in an information storage medium comprising, for example, a magnetic information storage medium, an optical information storage medium, an electronic information storage medium, and the like. By “electronic storage media,” Applicants mean, for example and without limitation, one or more devices, such as and without limitation, a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to assess the competency of a healthcare practitioner, comprising:
providing a learning object repository comprising a plurality of virtual objects including a plurality of virtual patients, wherein said learning object repository does not comprise a physical patient manikin;
displaying on a visual display device a virtual clinical world comprising a plurality of virtual objects retrieved from said learning object repository;
selecting by a practitioner a virtual patient from said virtual clinical world;
selecting by said practitioner a series of patient assessment interactions with said patient;
tracking said selected patient interactions;
selecting by said practitioner patient data;
tracking said selected patient data;
generating an AssessMap reciting an assessment grid comprising a plurality of Performance Levels in combination with a plurality of categories for each Performance Level.

2. The method of claim 1, further comprising:
selecting a plurality of Performance Levels and a plurality of Categories;
assigning an assessment for each Performance Level and Category, wherein a plurality of (N) Performance Levels and a plurality of (M) Categories comprises a total of (N) times (M) reported assessments.

3. The method of claim 2, further comprising creating a misconception analysis using said assessments.

4. The method of claim 3, wherein:
each assessment is selected from the group consisting of Passing, Needs Improvement, and Poor Performance; and
said misconception analysis comprises each Performance Level and Category assessment comprising either a Needs Improvement assessment or a Poor Performance assessment.

5. The method of claim 4, further comprising:
providing a first module comprising a first computer processor, a first computer readable medium, and first computer readable program code encoded in said first computer readable medium;
creating a first template by said first module, wherein said first template comprises one or more previously-defined learning objectives;
providing said first template to said learning object repository;
providing a second module comprising a second computer processor, a second computer readable medium, and second computer readable program code encoded in said second computer readable medium;
creating a second template by said second module, wherein said second template comprises one or more previously-defined competency assessments related to said one or more selected learning objectives;
providing said second template to said learning object repository;

6. The method of claim 5, further comprising:
providing a third module comprising a third computer processor, a third computer readable medium, and third computer readable program code encoded in said third computer readable medium;
wherein said tracking is performed by said third module;
creating a third template by said third module, wherein said third template comprises instructions to modify said virtual clinical world based upon said tracked patient interactions and said tracked patient data.

7. The method of claim 6, further comprising:
providing a fourth module comprising a fourth computer processor, a fourth computer readable medium, and fourth computer readable program code encoded in said fourth computer readable medium;
creating a fourth template by said fourth module, wherein said fourth template comprises data sampling and data analysis instructions with respect to said selected patient interactions, said selected patient data, and virtual clinical world modifications.
determining by said fourth module a pattern of choices resulting from said practitioner's patient interactions within said virtual clinical world.

8. An article of manufacture comprising a microprocessor, a computer readable medium comprising computer readable program code disposed therein to assess the competency of a healthcare practitioner, the computer readable program code comprising a series of computer readable program steps to effect:
communicating with a learning object repository comprising a plurality of virtual objects including a plurality of virtual patients, wherein said learning object repository does not comprise a physical patient manikin;
displaying on a visual display device a virtual clinical world comprising a plurality of virtual objects retrieved from said learning object repository;
selecting a virtual patient from said virtual clinical world;
selecting a series of patient assessment interactions with said patient;
tracking said selected patient interactions;
selecting patient data;
tracking said selected patient data;
generating an AssessMap reciting an assessment grid comprising a plurality of Performance Levels in combination with a plurality of categories for each Performance Level.

9. The article of manufacture of claim 8, said computer readable program code further comprising a series of computer readable program steps to effect:
selecting a plurality of Performance Levels and a plurality of Categories;
assigning an assessment for each Performance Level and Category, wherein a plurality of (N) Performance Levels and a plurality of (M) Categories comprises a total of (N) times (M) reported assessments.

10. The article of manufacture of claim 9, said computer readable program code further comprising a series of computer readable program steps to effect creating a misconception analysis using said assessments.

11. The article of manufacture of claim 10, wherein:
each assessment is selected from the group consisting of Passing, Needs Improvement, and Poor Performance; and
said misconception analysis comprises each Performance Level and Category assessment comprising either a Needs Improvement assessment or a Poor Performance assessment.

12. The article of manufacture of claim 8, said computer readable program code further comprising a series of computer readable program steps to effect:
communicating with a first module comprising a first computer processor, a first computer readable medium, and first computer readable program code encoded in said first computer readable medium;
receiving from said first module a first template, wherein said first template comprises one or more previously-defined learning objectives;
communicating with a second module comprising a second computer processor, a second computer readable medium, and second computer readable program code encoded in said second computer readable medium;
receiving from said second module a second template, wherein said second template comprises one or more previously-defined competency assessments related to said one or more selected learning objectives;
communicating with a third module comprising a third computer processor, a third computer readable medium, and third computer readable program code encoded in said third computer readable medium;
wherein said tracking is performed by said third module;
receiving from said third module a third template, wherein said third template comprises instructions to modify said virtual clinical world based upon said tracked patient interactions and said tracked patient data.

13. The article of manufacture of claim 12, said computer readable program code further comprising a series of computer readable program steps to effect:
communicating with a fourth module comprising a fourth computer processor, a fourth computer readable medium, and fourth computer readable program code encoded in said fourth computer readable medium;
receiving from said fourth module a fourth template, wherein said fourth template comprises data sampling and data analysis instructions with respect to said selected patient interactions, said selected patient data, and virtual clinical world modifications;
determining a pattern of choices resulting from said practitioner's patient interactions within said virtual clinical world.

15. A computer program product encoded in a non-transitory computer readable medium said computer program product being useable with a programmable computer processor to assess the competency of a healthcare practitioner, the computer program product comprising:
computer readable program code which causes said programmable processor to communicate with a learning object repository comprising a plurality of virtual objects including a plurality of virtual patients, wherein said learning object repository does not comprise a physical patient manikin;
computer readable program code which causes said programmable processor to display on a visual display device a virtual clinical world comprising a plurality of virtual objects retrieved from said learning object repository;
computer readable program code which causes said programmable processor to receive via a data input device a selection made by a practitioner of a virtual patient from said virtual clinical world;
computer readable program code which causes said programmable processor to receive via a data input device one or more selections made by said practitioner, said selections comprising a series of patient interactions;
computer readable program code which causes said programmable processor to track said selected patient interactions;
computer readable program code which causes said programmable processor to receive via a data input device one or more selected patient data made by said practitioner;
computer readable program code which causes said programmable processor to track said selected patient data;
computer readable program code which causes said programmable processor to generate an AssessMap reciting an assessment grid comprising a plurality of Performance Levels in combination with a plurality of Categories for each Performance Level.

16. The computer program product of claim 15, further comprising:
computer readable program code which causes said programmable processor to select a plurality of Performance Levels and a plurality of Categories;
computer readable program code which causes said programmable processor to assign an assessment for each Performance Level and Category, wherein a plurality of (N) Performance Levels and a plurality of (M) Categories comprises a total of (N) times (M) reported assessments.

17. The computer program product of claim 16, further comprising computer readable program code which causes said programmable processor to create a misconception analysis using said assessments.

18. The computer program product of claim 17, wherein:
each assessment is selected from the group consisting of Passing, Needs Improvement, and Poor Performance; and
said misconception analysis comprises each Performance Level and Category assessment comprising either a Needs Improvement assessment or a Poor Performance assessment.

19. The computer program product of claim 15, further comprising:
computer readable program code which causes said programmable processor to communicate with a first module comprising a first computer processor, a first computer readable medium, and first computer readable program code encoded in said first computer readable medium;
computer readable program code which causes said programmable processor to receive from said first module a first template, wherein said first template comprises one or more previously-defined learning objectives;
computer readable program code which causes said programmable processor to communicate with a second module comprising a second computer processor, a second computer readable medium, and second computer readable program code encoded in said second computer readable medium;
computer readable program code which causes said programmable processor to receive from said second module a second template, wherein said second template comprises one or more previously-defined competency assessments related to said one or more selected learning objectives;
computer readable program code which causes said programmable processor to communicate with a third module comprising a third computer processor, a third computer readable medium, and third computer readable program code encoded in said third computer readable medium;
wherein said computer readable program code which causes said programmable processor to track said selected patient interactions is implemented by said third module;
wherein said computer readable program code which causes said programmable processor to track said selected patient data is implemented by said third module;
computer readable program code which causes said programmable processor to receive from said third module a third template, wherein said third template comprises instructions to modify said virtual clinical world based upon said tracked patient interactions and said tracked patient data.

20. The computer program product of claim 19, further comprising:
computer readable program code which causes said programmable processor to communicate with a fourth module comprising a fourth computer processor, a fourth computer readable medium, and fourth computer readable program code encoded in said fourth computer readable medium;
computer readable program code which causes said programmable processor to receive from said fourth module a fourth template, wherein said fourth template comprises data sampling and data analysis instructions with respect to said selected patient interactions, said selected patient data, and virtual clinical world modifications;
computer readable program code which causes said programmable processor to identify a pattern of choices resulting from said practitioner's patient interactions within said virtual clinical world.
